(19) United States
(12) Patent Application Publication
(10) Pub. No.: US 2017/0142728 A1
(43) Pub. Date: May 18, 2017

(54) MULTIPLE DETECTOR COORDINATION FOR MONITORING OF MULTIPLE CHANNELS IN THE DYNAMIC FREQUENCY SELECTION BAND

(71) Applicant: NETWORK PERFORMANCE RESEARCH GROUP LLC, Campbell, CA (US)

(72) Inventors: Kun Ting Tsai, Fremont, CA (US); Seung Yi, Norwich, VT (US); Terry Ngo, Bellevue, WA (US); Erick Kurniawan, San Francisco, CA (US)

(21) Appl. No.: 15/416,568

(22) Filed: Jan. 26, 2017

Related U.S. Application Data
(63) Continuation-in-part of application No. 14/920,568, filed on Oct. 22, 2015.
(60) Provisional application No. 62/200,764, filed on Aug. 4, 2015.
(60) Provisional application No. 62/395,669, filed on Sep. 16, 2016.

(51) Int. Cl. H04W 72/04; H04W 16/14; H04W 74/08; H04W 36/18; H04W 24/08

(52) U.S. Cl. CPC H04W 72/0453; H04W 36/18; H04W 24/08; H04W 74/0808; H04W 16/14; H04W 84/12

(57) ABSTRACT

Multiple detector coordination for monitoring of multiple channels in the dynamic frequency selection band is provided herein. A method includes performing a channel availability check on a first 5 GHz radio channel selected from a plurality of 5 GHz radio channels. The method can also include communicating to an access point device servicing a client that the first 5 GHz radio channel is available for use based on a first determination that the first 5 GHz radio channel does not comprise the first radar signal. The method can also include performing a soft handover of dynamic frequency selection functionalities to the access point device. The DFS functionalities comprise continuous in-service monitoring of the first 5 GHz radio channel. The radar detector, the beacon generator, and the 5 GHz radio transceiver discontinue continuous in-service monitoring of the first 5 GHz radio channel after the soft handover.

### CROSS-REFERENCE TO RELATED APPLICATIONS

This application is a continuation-in-part of U.S. Non-Provisional patent application Ser. No. 14/920,568 titled METHOD AND APPARATUS FOR USE OF SIMULTANEOUS MULTIPLE CHANNELS IN THE DYNAMIC FREQUENCY SELECTION BAND IN WIRELESS NETWORKS and filed on Oct. 22, 2015, which claims priority to U.S. Provisional Patent Application No. 62/200,764 titled METHOD AND APPARATUS FOR USE OF SIMULTANEOUS MULTIPLE CHANNELS IN THE DYNAMIC FREQUENCY SELECTION BAND IN WIRELESS NETWORKS and filed on Aug. 4, 2015. This application also claims priority to U.S. Provisional Patent Application No. 62/395,669 titled METHOD OF SOFT HANDOFF FOR IN SERVICE MONITORING IN DYNAMIC FREQUENCY SELECTION and filed on Sep. 16, 2016. The disclosures of the above noted applications are incorporated herein by reference in their entireties.

### BACKGROUND

Wi-Fi networks are used for today's portable modern life, including the Internet-of-Things (IoT). However, the technology supporting Wi-Fi networks has not kept up with demands. Further, the Wi-Fi network and its associated unlicensed spectrum are sometimes inefficiently managed. The net result can be growing congestion and slowed networks with unreliable connections. In a similar manner, LTE-U networks operating in the same or similar unlicensed bands as 802.11ac/n Wi-Fi suffer similar congestion and unreliable connection issues and can often create congestion problems for existing Wi-Fi networks sharing the same or similar channels.

Devices operating in certain parts of the 5 GHz U-NII-2 band, referred to as DFS (e.g., Dynamic Frequency Selection) channels, require active radar detection. This function is assigned to a device capable of detecting radar, which is referred to as a DFS master, which is typically an access point or router. The DFS master actively scans the DFS channels and performs a channel availability check (CAC) and periodic in-service monitoring (ISM) after the channel availability check. The channel availability check lasts sixty seconds as required by Federal Communication Commission (FCC) standards. The DFS master signals to the other devices in the network (typically client devices) by transmitting a DFS beacon indicating that the channel is clear of radar. Although the access point can detect radar, wireless clients typically cannot. Therefore, wireless clients passively scan DFS channels to detect whether a beacon is present on that particular channel. During a passive scan, the client device switches through channels and listens for a beacon transmitted at regular intervals by the access point on an available channel.

Once a beacon is detected, the client is allowed to actively scan on that channel. If the DFS master detects radar in that channel, the DFS master stops transmitting the beacon, and all client devices upon not sensing the beacon within a prescribed time must vacate the channel immediately and remain off that channel for 30 minutes. For clients associated with the DFS master network, additional information in the beacons (such as a channel switch announcement) can trigger a rapid and controlled evacuation of the channel. Normally, a DFS master device is an access point with only one radio and is able to provide DFS master services for only a single channel. A problem with this approach is, in the event of a radar event or a false-detect, the single channel must be vacated and the ability to use DFS channels is lost.

The above-described deficiencies of conventional networks are merely intended to provide an overview of some of problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with multiple detector coordination for monitoring of multiple channels in the dynamic frequency selection band. According to an aspect is a method of multiple detector coordination for in-service monitoring of available dynamic frequency selection channels free of radar signals selected from a plurality of 5 GHz radio frequency channels. The method can include providing a beacon generator to generate a first beacon in a first 5 GHz radio channel selected from the plurality of 5 GHz radio channels and providing a radar detector to scan for a first radar signal in the first 5 GHz radio channel. The method can also include providing a 5 GHz radio transceiver to transmit the first beacon in the first 5 GHz radio channel and to receive the first radar signal in the first 5 GHz radio channel. Further, the method can include providing a switch and embedded processor coupled to the radar detector, the beacon generator, and the 5 GHz radio transceiver. With the switch and the embedded processor, the method can include communicating to an access point device servicing a client that the first 5 GHz radio channel is available for use based on a first determination that the first 5 GHz radio channel does not comprise the first radar signal. Also with the switch and the embedded processor, the method can include performing a soft handover of dynamic frequency selection functionalities to the access point device. The dynamic frequency selection functionalities can comprise continuous in-service monitoring of the first 5 GHz radio channel. Further, the radar detector, the beacon generator, and the 5 GHz radio transceiver discontinue the continuous in-service monitoring of the first 5 GHz radio channel.

Another aspect can relate to a standalone multi-channel dynamic frequency selection master, which can comprise a beacon generator programmed to generate a first beacon in a first 5 GHz radio channel selected from a set of 5 GHz radio channels and a radar detector programmed to scan for a first radar signal in the first 5 GHz radio channel. The standalone multi-channel dynamic frequency selection master can also include a 5 GHz radio transceiver programmed to transmit the first beacon in the first 5 GHz radio channel. The 5 GHz radio transceiver can also be programmed to receive the first radar signal in the first 5 GHz radio channel. Further, the standalone multi-channel dynamic frequency selection master can include a switch and embedded processor coupled to the radar detector, the beacon generator, and the 5 GHz radio transceiver. The switch and the embedded processor can be programmed to communicate to an access point device servicing a client that the first 5 GHz radio channel is available for use based on a first determination that the first 5 GHz radio channel does not comprise the first radar signal. Further, the switch and the embedded processor can be programmed to perform a soft handover of dynamic frequency selection functionalities to the access point device. The dynamic frequency selection functionalities can comprise continuous in-service monitoring of the first 5 GHz radio channel. In addition, the radar detector, the beacon generator, and the 5 GHz radio transceiver can discontinue the continuous in-service monitoring of the first 5 GHz radio channel.

A further aspect can relate to a method that can include determining, by a device comprising a processor, whether radar is detected on a first dynamic frequency selection radio channel and sending to a first access point, by the device, an indication that the first dynamic frequency selection radio channel is available for use by the first access point. The method can also include relinquishing control, by the device, an in-service monitoring of the first dynamic frequency selection radio channel based on receipt of another indication that the first access point has commenced the in-service monitoring of the first dynamic frequency selection radio channel. Further, the method can include determining, by the device, whether radar is detected on a second dynamic frequency selection radio channel and performing, by the device, in-service monitoring of the second dynamic frequency selection radio channel.

To the accomplishment of the foregoing and related ends, one or more aspects comprise features hereinafter fully described and particularly pointed out in the claims. The following description and annexed drawings set forth in detail certain illustrative features of one or more aspects. These features are indicative, however, of but a few of various ways in which principles of various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The aforementioned objects and advantages of the various aspects, as well as additional objects and advantages thereof, will be more fully understood herein after as a result of a detailed description of a preferred embodiment when taken in conjunction with the following drawings in which:

FIG. 1 illustrates portions of the 5 GHz Wi-Fi spectrum including portions that require active monitoring for radar signals.

FIG. 2 illustrates how such an exemplary autonomous DFS master may interface with a conventional host access point, a cloud-based intelligence engine, and client devices in accordance with one or more embodiments.

FIG. 3 illustrates how an exemplary autonomous DFS master in a peer-to-peer network may interface with client devices and the cloud intelligence engine independent of any access point, in accordance with one or more embodiments.

FIG. 4 illustrates a method of performing a channel availability check phase and in-service monitoring phase in a DFS scanning operation with an autonomous DFS master to make multiple DFS channels of the 5 GHz band simultaneously available for use according one or more embodiments using a time-division multiplexed sequential channel availability check followed by continuous in-service monitoring.

FIG. 5 illustrates a method of performing a channel availability check phase and in-service monitoring phase in a DFS scanning operation with an autonomous DFS master to make multiple DFS channels of the 5 GHz band simultaneously available for use according to one or more embodiments using a continuous sequential channel availability check followed by continuous in-service monitoring.

FIG. 6A illustrates a method of performing a channel availability check phase and in-service monitoring phase in a DFS scanning operation with an autonomous DFS master to make multiple DFS channels of the 5 GHz band simultaneously available for use according to one or more embodiments.

FIG. 6B illustrates an exemplary beacon transmission duty cycle and an exemplary radar detection duty cycle.

FIG. 7 illustrates one or more embodiments in which the agility agent is connected to a host device and connected to a network via the host device.

FIG. 8 illustrates one or more embodiments in which the agility agent is connected to a host device and connected to a network and a cloud intelligence engine via the host device.

FIG. 9 illustrates one or more embodiments in which the agility agent is connected to a host device and connected to a network and a cloud intelligence engine via the host device.

FIG. 10 illustrates a method of performing a channel availability check and in-service monitoring of one or more embodiments.

FIG. 11 illustrates another method of performing a channel availability check and in-service monitoring of one or more embodiments.

FIG. 12 illustrates another method of performing a channel availability check and in-service monitoring of one or more embodiments.

FIG. 13 illustrates an example, non-limiting network that provides multiple detector coordination for monitoring of multiple channels in a dynamic frequency selection band accordance with one or more embodiments described herein.

FIG. 14 illustrates an example, non-limiting system that can perform soft handover of dynamic frequency selection functionalities in accordance with one or more embodiments described herein.

FIG. 15 illustrates an example, non-limiting system that includes multiple access point devices, wherein respective dynamic frequency selection functionalities are handed over to one or more access point devices in accordance with one or more embodiments described herein.

FIG. 16 illustrates an example, non-limiting system for handover of dynamic frequency selection functionalities in accordance with one or more embodiments described herein.

FIG. 17 illustrates an example, non-limiting system for continuous in-service monitoring of a 5 GHz radio channel by an access point after a channel availability check has been performed on the 5 GHz radio channel, the access point can include multiple antennas and a central processing unit in accordance with one or more embodiments described herein.

FIG. 18 illustrates an example, non-limiting flow chart for in-service monitoring of available dynamic frequency selection channels free of radar signals selected from a plurality of 5 GHz radio frequency channels in accordance with one or more embodiments described herein.

FIG. 19 illustrates an example, non-limiting flow chart for soft handoff of continuous in-service monitoring of a dynamic frequency selection channel in accordance with one or more embodiments described herein.

FIG. 20 illustrates an example non-limiting method for performing a channel availability check on a 5 GHz radio channel at a first device and performing continuous in-service monitoring of the 5 GHz radio channel at a second device in accordance with one or more embodiments described herein.

FIG. 21 illustrates an example non-limiting method for in-service monitoring soft handover during an access point device configuration change in accordance with one or more embodiments described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

An aspect relates to wireless networks and more specifically to systems and methods for selecting available channels free of occupying signals from a plurality of radio frequency channels. As used herein, a channel “free” of occupying signals may include a channel with occupying signals that are lower than a signal threshold including signal strength, quantity, or traffic. An aspect employs a wireless agility agent to access additional bandwidth for wireless networks, such as IEEE 802.11ac/n and LTE-U networks. The additional bandwidth is derived from channels that require avoidance of occupying signals. For example, additional bandwidth is derived from special compliance channels that require radar detection—such as the DFS channels of the U-NII-2 bands—by employing multi-channel radar detection and in-service monitoring, and active channel selection controls. The DFS master actively scans the DFS channels and performs a channel availability check and periodic in-service monitoring after the channel availability check.

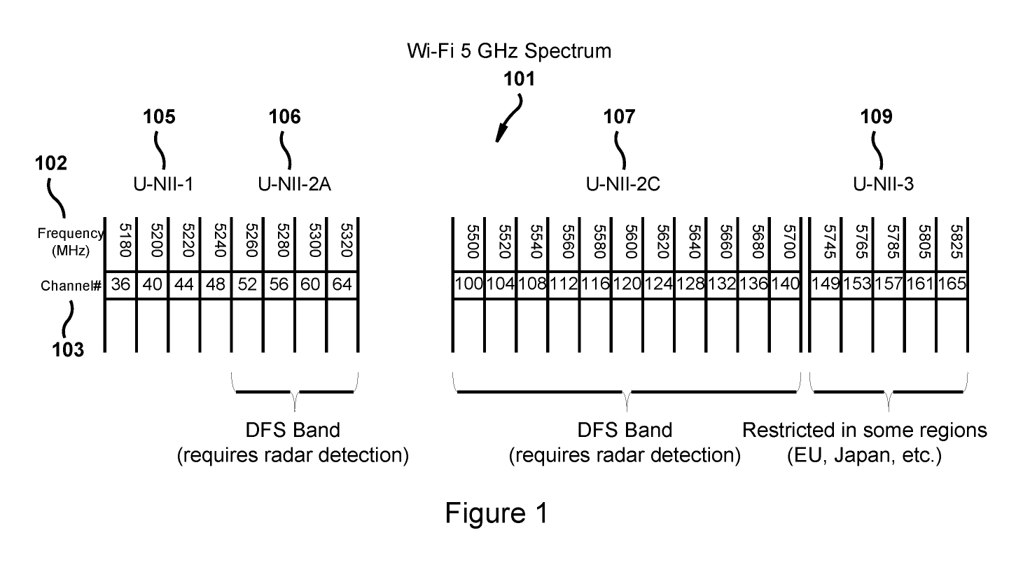

FIG. 1 illustrates portions of the 5 GHz Wi-Fi spectrum 101. FIG. 1 shows the frequencies 102 and channels 103 that make up portions of the 5 GHz Wi-Fi spectrum 101. The U-NII band is an FCC regulatory domain for 5-GHz wireless devices and is part of the radio frequency spectrum used by IEEE 802.11ac/n devices and by many wireless ISPs. It operates over four ranges. The U-NII-1 band 105 covers the 5.15-5.25 GHz range. The U-NII-2A band 106 covers the 5.25-5.35 GHz range. The U-NII-2A band 106 is subject to DFS radar detection and avoidance requirements. The U-NII-2C band 107 covers the 5.47-5.725 GHz range. The U-NII-2C band 107 is also subject to DFS radar detection and avoidance requirements. The U-NII-3 band 109 covers the 5.725 to 5.850 GHz range. Use of the U-NII-3 band 109 is restricted in some jurisdictions like the European Union and Japan.

When used in an 802.11ac/n or LTE-U wireless network, the agility agent of the one or more embodiments functions as an autonomous DFS master device. In contrast to conventional DFS master devices, the agility agent is not an access point or router, but rather is a standalone wireless device employing inventive scanning techniques described herein that provide DFS scan capabilities across multiple channels, enabling one or more access point devices and peer-to-peer client devices to exploit simultaneous multiple DFS channels. The standalone autonomous DFS master of one or more embodiments may be incorporated into another device such as an access point, LTE-U host, base station, cell, or small cell, media or content streamer, speaker, television, mobile phone, mobile router, software access point device, or peer to peer device but does not itself provide network access to client devices. In particular, in the event of a radar event or a false-detect, the enabled access point and clients or wireless device are able to move automatically, predictively and very quickly to another DFS channel.

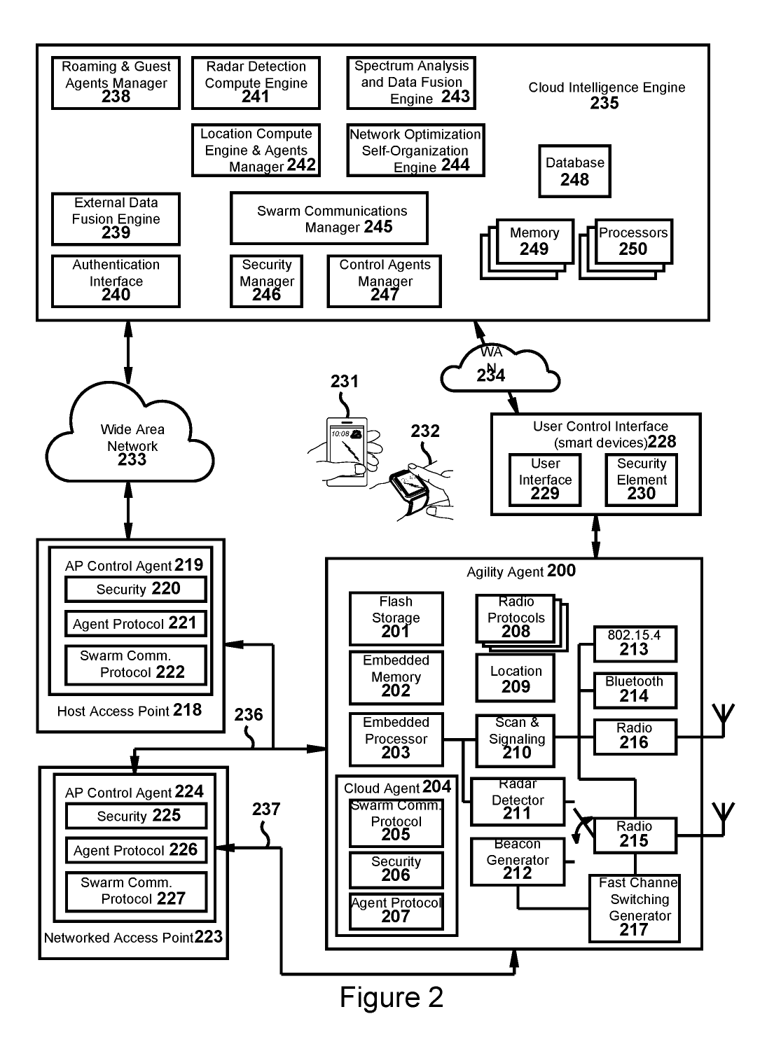

FIG. 2 provides a detailed illustration of an exemplary system of one or more embodiments. As illustrated in FIG. 2, the agility agent 200, in the role of an autonomous DFS master device, may control at least one access point, the host access point 218, to dictate channel selection primarily by (a) signaling availability of one or more DFS channels by simultaneous transmission of one or more beacon signals; (b) transmitting a listing of both the authorized available DFS channels, herein referred to as a whitelist, and the prohibited DFS channels in which a potential radar signal has been detected, herein referred to as a blacklist, along with control signals and a time-stamp signal, herein referred to as a dead-man switch timer via an associated non-DFS channel; (c) transmitting the same signals as (b) over a wired medium such as Ethernet or serial cable; and (d) receiving control, coordination and authorized and preferred channel selection guidance information from the cloud intelligence engine 235. The agility agent 200 sends the time-stamp signal, or dead-man switch timer, with communications to ensure that the access points 218, 223 do not use the information, including the whitelist, beyond the useful lifetime of the information. For example, a whitelist will only be valid for certain period of time. The time-stamp signal avoids using noncompliant DFS channels by ensuring that an access point will not use the whitelist beyond its useful lifetime. The one or more embodiments allows currently available 5 GHz access points without radar detection—which cannot operate in the DFS channels—to operate in the DFS channels by providing the radar detection required by the FCC or other regulatory agencies.

The host access point 218 and any other access point devices 223 under control of the autonomous DFS master 200 typically have the control agent portion 219, 224 installed within their communication stack. The control agent 219, 224 is an agent that acts under the direction of the agility agent 200 to receive information and commands from the agility agent 200. The control agent 219, 224 acts on information from the agility agent 200. For example, the control agent 219, 224 listens for information like a whitelist or blacklist from the agility agent. If a radar signal is detected by the agility agent 200, the agility agent 200 communicates that to the control agent 219, 224, and the control agent 219, 224 acts to evacuate the channel immediately. The control agent can also take commands from the agility agent 200. For example, the host access point 218 and network access point 223 can offload DFS monitoring to the agility agent 200 as long as they can listen to the agility agent 200 and take commands from the agility agent regarding available DFS channels.

The host access point 218 is connected to a wide area network 233 and includes an access point control agent 219 to facilitate communications with the agility agent 200. The access point control agent 219 includes a security module 220 and agent protocols 221 to facilitate communication with the agility agent 200, and swarm communication protocols 222 to facilitate communications between agility agents, access points, client devices, and other devices in the network. The agility agent 200 connects to the cloud intelligence engine 235 via the host access point 218 and the wide area network 233. The access point sets up a secure tunnel to communicate with the cloud intelligence engine 235 through, for example, an encrypted control API in the host access point 218. The agility agent 200 transmits information to the cloud intelligence engine 235 such as whitelists, blacklists, state information, location information, time signals, scan lists (for example, showing neighboring access points), congestion (for example, number and type of re-try packets), and traffic information. The cloud intelligence engine 235 communicates information to the agility agent 200 via the secure communications tunnel such as access point location (including neighboring access points), access point/cluster current state and history, statistics (including traffic, congestion, and throughput), whitelists, blacklists, authentication information, associated client information, and regional and regulatory information. The agility agent 200 uses the information from the cloud intelligence engine 235 to control the access points and other network devices.

The agility agent 200 may communicate via wired connections or wirelessly with the other network components. In the illustrated example, the agility agent 200 includes a primary radio 215 and a secondary radio 216. The primary radio 215 is for DFS and radar detection and is typically a 5 GHz radio. The agility agent 200 may receive radar signals, traffic information, and/or congestion information through the primary radio 215. And the agility agent 200 may transmit information such as DFS beacons via the primary radio 215. The second radio 216 is a secondary radio for sending control signals to other devices in the network and is typically a 2.4 GHz radio. The agility agent 200 may receive information such as network traffic, congestion, and/or control signals with the secondary radio 216. And the agility agent 200 may transmit information such as control signals with the secondary radio 216. The primary radio 215 is connected to a fast channel switching generator 217 that includes a switch and allows the primary radio 215 to switch rapidly between a radar detector 211 and beacon generator 212. The channel switching generator 217 allows the radar detector 211 to switch sufficiently fast to appear to be on multiple channels at a time.

In one embodiment, a standalone multi-channel DFS master includes a beacon generator 212 to generate a beacon in each of a plurality of 5 GHz radio channels, a radar detector 211 to scan for a radar signal in each of the plurality of 5 GHz radio channels, a 5 GHz radio transceiver 215 to transmit the beacon in each of the plurality of 5 GHz radio channels and to receive the radar signal in each of the plurality of 5 GHz radio channels, and a fast channel switching generator 217 coupled to the radar detector, the beacon generator, and the 5 GHz radio transceiver. The fast channel switching generator 217 switches the 5 GHz radio to a first channel of the plurality of 5 GHz radio channels and then causes the beacon generator 212 to generate the beacon in the first channel of the plurality of 5 GHz radio channels. Then the fast channel switching generator 217 causes the radar detector 211 to scan for the radar signal in the first channel of the plurality of 5 GHz radio channels. The fast channel switching generator 217 then repeats these steps for each other channel of the plurality of 5 GHz radio channels during a beacon transmission duty cycle and, in some examples, during a radar detection duty cycle. The beacon transmission duty cycle is the time between successive beacon transmissions on a given channel and the radar detection duty cycle which is the time between successive scans on a given channel. Because the agility agent 200 cycles between beaconing and scanning in each of the plurality of 5 GHz radio channels in the time window between a first beaconing and scanning in a given channel and a subsequent beaconing and scanning the same channel, it can provide effectively simultaneous beaconing and scanning for multiple channels.

The agility agent 200 also may contain a Bluetooth radio 214 and an 802.15.4 radio 213 for communicating with other devices in the network. The agility agent 200 may include various radio protocols 208 to facilitate communication via the included radio devices.

The agility agent 200 may also include a location module 209 to geolocate or otherwise determine the location of the agility agent 200. As shown in FIG. 2, the agility agent 200 may include a scan and signaling module 210. The agility agent 200 includes embedded memory 202, including for example flash storage 201, and an embedded processor 203. The cloud agent 204 in the agility agent 200 facilitates aggregation of information from the cloud agent 204 through the cloud and includes swarm communication protocols 205 to facilitate communications between agility agents, access points, client devices, and other devices in the network. The cloud agent 204 also includes a security module 206 to protect and secure the agility agent's 200 cloud communications as well as agent protocols 207 to facilitate communication with the access point control agents 219, 224.

As shown in FIG. 2, the agility agent 200 may control other access points, for example networked access point 223, in addition to the host access point 218. The agility agent 200 may communicate with the other access points 223 via a wired or wireless connection 236, 237. The other access points 223 include an access point control agent 224 to facilitate communication with the agility agent 200 and other access points. The access point control agent 224 includes a security module 225, agent protocols 226 and swarm communication protocols 227 to facilitate communications with other agents (including other access points and client devices) on the network.

The cloud intelligence engine 235 includes a database 248 and memory 249 for storing information from the agility agent 200, other agility agents (not shown) connected to the intelligence engine 235, and external data sources (not shown). The database 248 and memory 249 allow the cloud intelligence engine 235 to store information over months and years received from agility agents and external data sources.

The cloud intelligence engine 235 also includes processors 250 to perform the cloud intelligence operations described herein. The roaming and guest agents manager 238 in the cloud intelligence engine 235 provides optimized connection information for devices connected to agility agents that are roaming from one access point to other or from one access point to another network. The roaming and guest agents manager 238 also manages guest connections to networks for agility agents connected to the cloud intelligence engine 235. The external data fusion engine 239 provides for integration and fusion of information from agility agents with information from external data sources for example GIS information, other geographical information, FCC information regarding the location of radar transmitters, FCC blacklist information, NOAA databases, DOD information regarding radar transmitters, and DOD requests to avoid transmission in DFS channels for a given location. The cloud intelligence engine 235 further includes an authentication interface 240 for authentication of received communications and for authenticating devices and users. The radar detection compute engine 241 aggregates radar information from agility agents and external data sources and computes the location of radar transmitters from those data to, among other things, facilitate identification of false positive radar detections or hidden nodes and hidden radar. The radar detection compute engine 241 may also guide or steer multiple agility agents to dynamically adapt detection parameters and/or methods to further improve detection sensitivity. The location compute and agents manager 242 determines the location the agility agent 200 and other connected devices through Wi-Fi lookup in a Wi-Fi location database, querying passing devices, scan lists from agility agents, or geometric inference.

The spectrum analysis and data fusion engine 243 and the network optimization self-organization engine 244 facilitate dynamic spectrum optimization with information from the agility agents and external data sources. Each of the agility agents connected to the cloud intelligence engine 235 have scanned and analyzed the local spectrum and communicated that information to the cloud intelligence engine 235. The cloud intelligence engine 235 also knows the location of each agility agent and the access points proximate to the agility agents that do not have a controlling agent as well as the channel on which each of those devices is operating. With this information, the spectrum analysis and data fusion engine 243 and the network optimization self-organization engine 244 can optimize the local spectrum by telling agility agents to avoid channels subject to interference. The swarm communications manager 245 manages communications between agility agents, access points, client devices, and other devices in the network. The cloud intelligence engine includes a security manager 246. The control agents manager 247 manages all connected control agents.

Independent of a host access point 218, the agility agent 200, in the role of an autonomous DFS master device, may also provide the channel indication and channel selection control to one or more peer-to-peer client devices 231, 232 within the coverage area by (a) signaling availability of one or more DFS channels by simultaneous transmission of one or more beacon signals; (b) transmitting a listing of both the authorized available DFS channels, herein referred to as a whitelist and the prohibited DFS channels in which a potential radar signal has been detected, herein referred to as a blacklist along with control signals and a time-stamp signal, herein referred to as a dead-man switch timer via an associated non-DFS channel; and (c) receiving control, coordination and authorized and preferred channel selection guidance information from the cloud intelligence engine 235. The agility agent 200 sends the time-stamp signal, or dead-man switch timer, with communications to ensure that the devices do not use the information, including the whitelist, beyond the useful lifetime of the information. For example, a whitelist will only be valid for certain period of time. The time-stamp signal avoids using noncompliant DFS channels by ensuring that a device will not use the whitelist beyond its useful lifetime.

Such peer-to-peer devices may have a user control interface 228. The user control interface 228 includes a user interface 229 to allow the client devices 231, 232 to interact with the agility agent 200 via the cloud intelligence engine 235. For example, the user interface 229 allows the user to modify network settings via the agility agent 200 including granting and revoking network access. The user control interface 228 also includes a security element 230 to ensure that communications between the client devices 231, 232 and the agility agent 200 are secure. The client devices 231, 232 are connected to a wide area network 234 via a cellular network for example. Peer-to-peer wireless networks are used for direct communication between devices without an access point. For example, video cameras may connect directly to a computer to download video or images files using a peer-to-peer network. Also, device connections to external monitors and device connections to drones currently use peer-to-peer networks. Because there is no access point in a peer-to-peer network, traditional peer-to-peer networks cannot use the DFS channels because there is no access point to control the DFS channel selection and tell the devices what DFS channels to use. The one or more embodiments overcome this limitation.

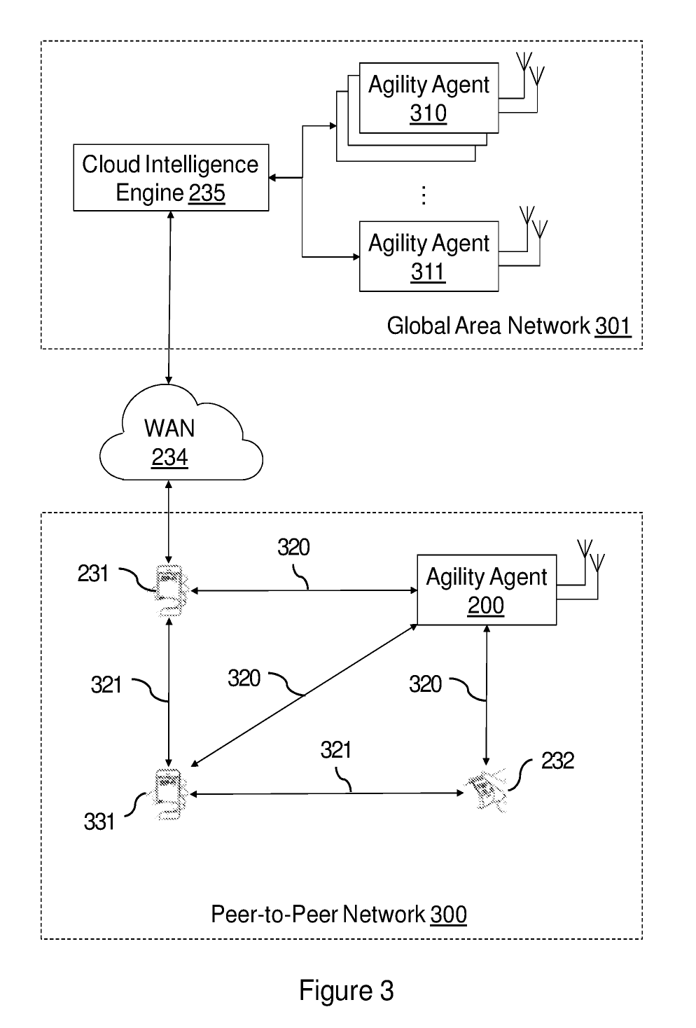

FIG. 3 illustrates how the agility agent 200 acting as an autonomous DFS master in a peer-to-peer network 300 (a local area network for example) would interface to client devices 231, 232, 331 and the cloud intelligence engine 235 independent of any access point, in accordance with one or more embodiments. As shown in FIG. 3, the cloud intelligence engine 235 may be connected to a plurality of network-connected agility agents 200, 310. The agility agent 200 in the peer-to-peer network 300 may connect to the cloud intelligence engine 235 through one of the network-connected client devices 231, 331 by, for example, piggy-backing a message to the cloud intelligence engine 235 on a message send to the client devices 231, 331 or otherwise coopting the client devices' 231, 331 connection to the wide area network 234. In the peer-to-peer network 300, the agility agent 200 sends over-the-air control signals 320 to the client devices 231, 232, 331 including indications of channels free of occupying signals such as DFS channels free of radar signals. Alternatively, the agility agent communicates with just one client device 331 which then acts as the group owner to initiate and control the peer-to-peer communications with other client devices 231, 232. The client devices 231, 232, 331 have peer-to-peer links 321 through which they communicate with each other.

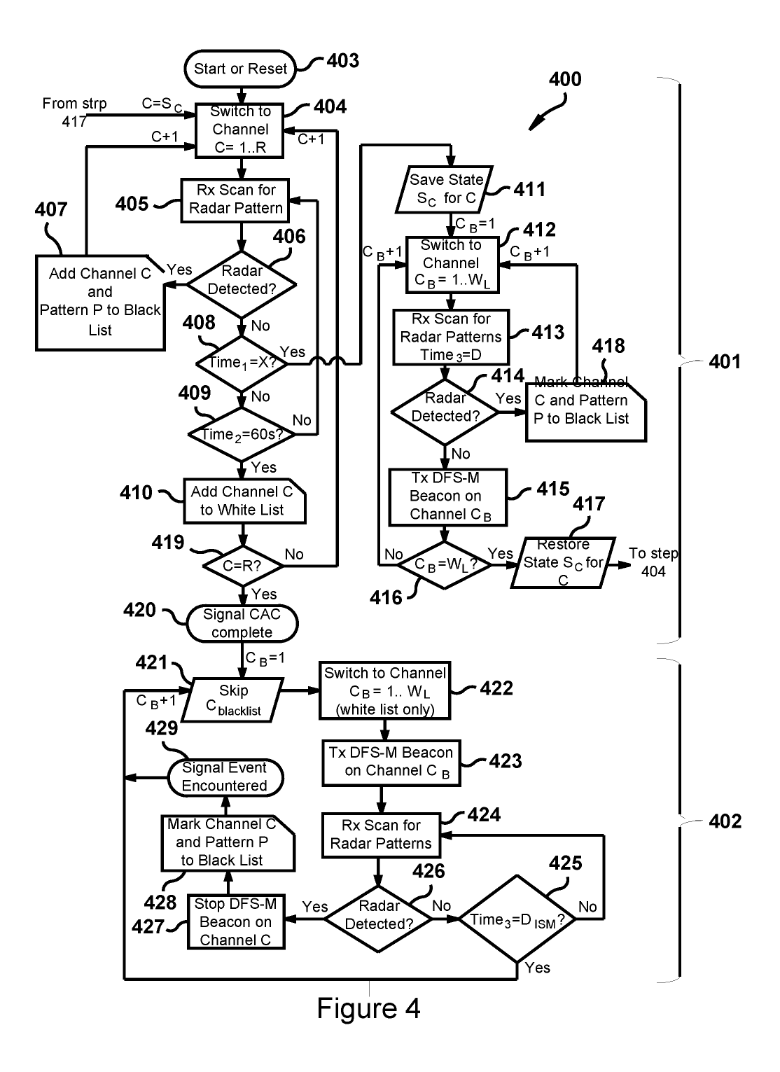

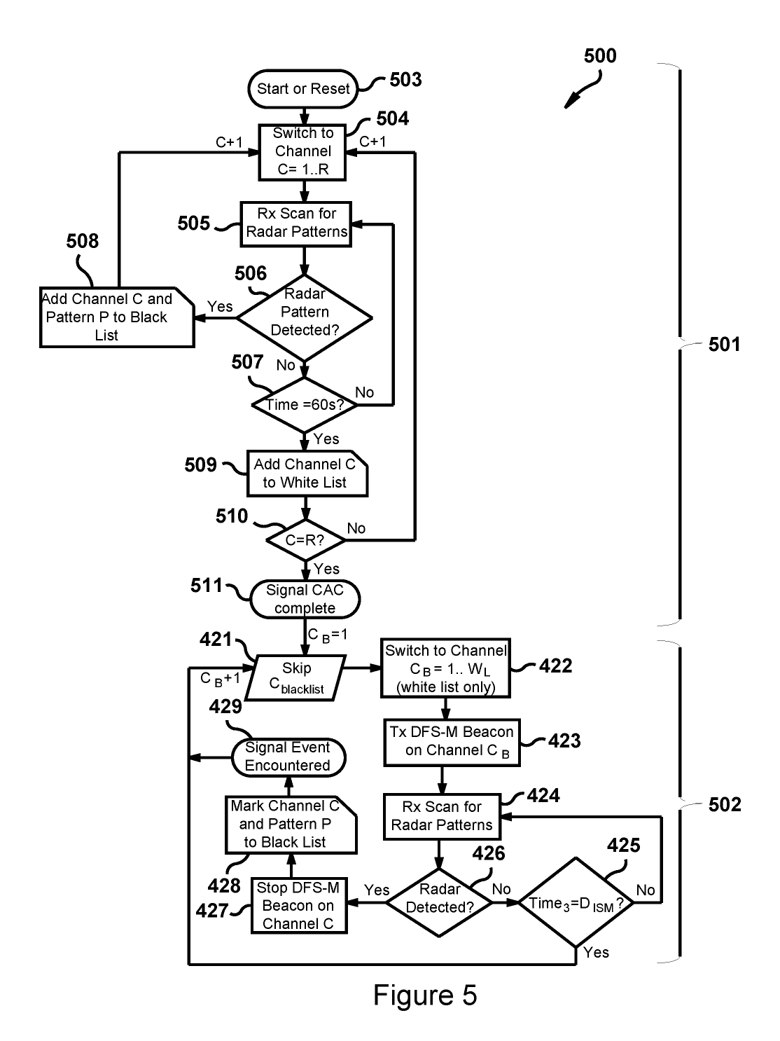

The agility agent may operate in multiple modes executing a number of DFS scan methods employing different algorithms. Two of these methods are illustrated in FIG. 4 and FIG. 5.

FIG. 4 illustrates a first DFS scan method 400 for a multi-channel DFS master of one or more embodiments. This method uses a time division sequential CAC 401 followed by continuous ISM 402. The method begins at step 403 with the multi-channel DFS master at startup or after a reset. At step 404 the embedded radio is set to receive (Rx) and is tuned to the first DFS channel (C=1). In one example, the first channel is channel 52. Next, because this is the first scan after startup or reset and the DFS master does not have information about channels free of radar, the DFS master performs a continuous CAC 405 scan for a period of 60 seconds (compliant with the FCC Part 15 Subpart E and ETSI 301 893 requirements). At step 406 the DFS master determines if a radar pattern is present in the current channel. If radar pattern is detected 407, then the DFS master marks this channel in the blacklist. The DFS master may also send additional information about the detected radar including the signal strength, radar pattern, type of radar, and a time stamp for the detection.

At the first scan after startup or reset, if a radar pattern is detected in the first channel scanned, the DFS master may repeat the above steps until a channel free of radar signals is found. Alternatively, after a startup or reset, the DFS master may be provided a whitelist indicating one or more channels that have been determined to be free of radar signals. For example, the DFS master may receive a message that channel 52 is free of radar signals from the cloud intelligence engine 235 along with information fused from other sources.

If at step 406 the DFS master does not detect a radar pattern 410, the DFS master marks this channel in the whitelist and switches the embedded radio to transmit (Tx) (not shown in FIG. 4) at this channel. The DFS master may include additional information in the whitelist including a time stamp. The DFS master then transmits (not shown in FIG. 4) a DFS master beacon signal for minimum required period of n (which is the period of the beacon transmission defined by IEEE 802.11 requirements, usually very short on the order of a few microseconds). A common SSID may be used for all beacons of our system.

For the next channel scan after the DFS master finds a channel free of radar, the DFS master sets the radio to receive and tunes the radio to the next DFS channel 404 (for example channel 60). The DFS master then performs a non-continuous CAC radar detection scan 405 for period of X, which is the maximum period between beacons allowable for a client device to remain associated with a network (P_{M}) less a period of n required for a quick radar scan and the transmission of the beacon itself (X=P_{M}−n) 408. At 411, the DFS master saves the state of current non-continuous channel state (S_{C}) from the non-continuous CAC scan so that the DFS master can later resume the current non-continuous channel scan at the point where the DFS master left off. Then, at step 412, the DFS master switches the radio to transmit and tunes to the first DFS channel (in this example it was CH 52), performs quick receive radar scan 413 (for a period of D called the dwell time) to detect radar 414. If a radar pattern is detected, the DFS master marks the channel to the blacklist 418. When marking the channel to the blacklist, the DFS master may also include additional information about the detected radar pattern including signal strength, type of radar, and a time stamp for the detection. If no radar pattern is detected, the DFS master transmits again 415 the DFS master beacon for the first channel (channel 52 in the example). Next, the DFS master determines if the current channel (C_{B}) is the last channel in the whitelist (W_{L}) 416. In the current example, the current channel, channel 52, is the only channel in the whitelist at this point. Then, the DFS master restores 417 the channel to the saved state from step 411 and switches the radio back to receive mode and tunes the radio back to the current non-continuous CAC DFS channel (channel 60 in the example) 404. The DFS master then resumes the non-continuous CAC radar scan 405 for period of X, again accommodating the period of n required for the quick scan and transmission of the beacon. This is repeated until 60 seconds of non-continuous CAC scanning is accumulated 409—in which case the channel is marked in the whitelist 410—or until a radar pattern is detected—in which case this channel is marked in the blacklist 407.

Next, the DFS master repeats the procedure in the preceding paragraph for the next DFS channel (for example channel 100). The DFS master periodically switches 412 to previous whitelisted DFS channels to do a quick scan 413 (for a period of D called the dwell time), and if no radar pattern detected, transmits a beacon 415 for period of n in each of the previously CAC scanned and whitelisted DFS channels. Then the DFS master returns 404 to resume the non-continuous CAC scan 405 of the current CAC channel (in this case CH 100). The period X available for non-continuous CAC scanning before switching to transmit and sequentially beaconing the previously whitelisted CAC scanned channels is reduced by n for each of the previously whitelisted CAC scanned channels, roughly X=P_{M}−n*(W_{L}) where W_{L} is the number of previously whitelisted CAC scanned channels. This is repeated until 60 seconds of non-continuous CAC scanning is accumulated for the current channel 409. If no radar pattern is detected the channel is marked in the whitelist 410. If a radar pattern is detected, the channel is marked in the blacklist 407 and the radio can immediately switch to the next DFS channel to be CAC scanned.

The steps in the preceding paragraph are repeated for each new DFS channel until all desired channels in the DFS band have been CAC scanned. In FIG. 4, step 419 checks to see if the current channel C is the last channel to be CAC scanned R. If the last channel to be CAC scanned R has been reached, the DFS master signals 420 that the CAC phase 401 is complete and begins the ISM phase 402. The whitelist and blacklist information may be communicated to the cloud intelligence engine where it is integrated over time and fused with similar information from other agility agents.

During the ISM phase, the DFS master does not scan the channels in the blacklist 421. The DFS master switches 422 to the first channel in the whitelist and transmits 423 a DFS beacon on that channel. Then the DFS master scans 424 the first channel in the whitelist for a period of D_{ISM} (the ISM dwell time) 425, which may be roughly P_{M} (the maximum period between beacons allowable for a client device to remain associated with a network) minus n times the number of whitelisted channels, divided by the number of whitelisted channels (D_{ISM}=(P_{M}−n*W_{L})/n). Then the DFS master transmits 423 a beacon and scans 424 each of the channels in the whitelist for the dwell time and then repeats starting at the first channel in the whitelist 422 in a round robin fashion for each respective channel. If a radar pattern is detected 426, the DFS master beacon for the respective channel is stopped 427, and the channel is marked in the blacklist 428 and removed from the whitelist (and no longer ISM scanned). The DFS master sends alert messages 429, along with the new whitelist and blacklist to the cloud intelligence engine. Alert messages may also be sent to other access points and/or client devices in the network.

FIG. 5 illustrates a second DFS scan method 500 for a multi-channel DFS master of the one or more embodiments. This method uses a continuous sequential CAC 501 followed by continuous ISM 502. The method begins at step 503 with the multi-channel DFS master at startup or after a reset. At step 504 the embedded radio is set to receive (Rx) and is tuned to the first DFS channel (C=1). In this example, the first channel is channel 52. The DFS master performs a continuous CAC scan 505 for a period of 60 seconds 507 (compliant with the FCC Part 15 Subpart E and ETSI 301 893 requirements). If radar pattern is detected at step 506 then the DFS master marks this channel in the blacklist 508.

If the DFS master does not detect radar patterns, it marks this channel in the whitelist 509. The DFS master determines if the current channel C is the last channel to be CAC scanned R at step 510. If not, then the DFS master tunes the receiver to the next DFS channel (for example channel 60) 504. Then the DFS master performs a continuous scan 505 for full period of 60 seconds 507. If a radar pattern is detected, the DFS master marks the channel in the blacklist 508 and the radio can immediately switch to the next DFS channel 504 and repeat the steps after step 504.

If no radar pattern is detected 509, the DFS master marks the channel in the whitelist 509 and then tunes the receiver next DFS channel 504 and repeats the subsequent steps until all DFS channels for which a CAC scan is desired. Unlike the method depicted in FIG. 4, no beacon is transmitted between CAC scans of sequential DFS channels during the CAC scan phase.

The ISM phase 502 in FIG. 5 is identical to that in FIG. 4 described above.

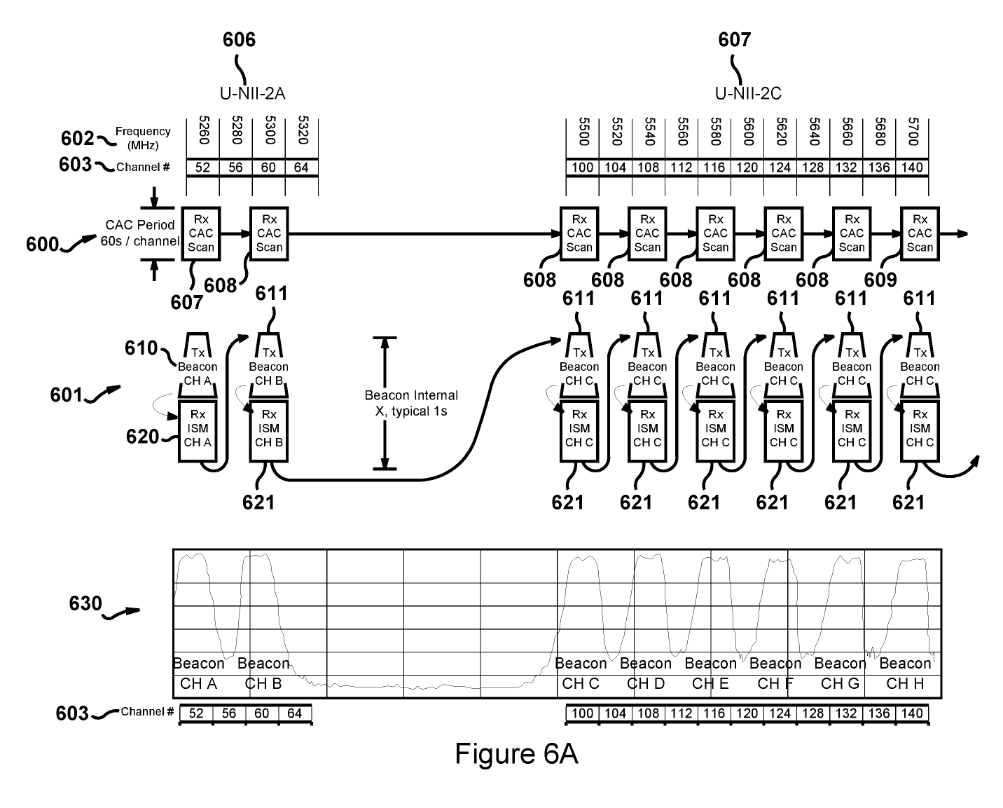

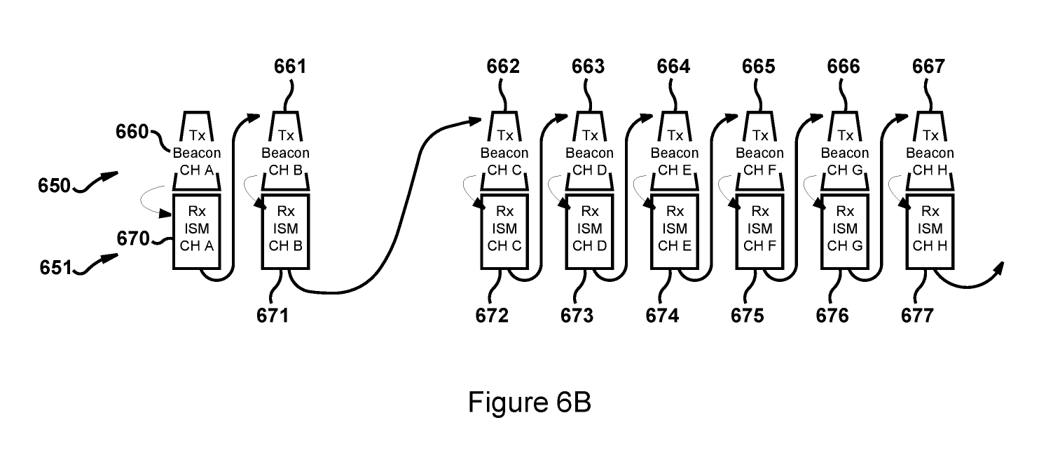

FIG. 6A illustrates how multiple channels in the DFS channels of the 5 GHz band are made simultaneously available by use of one or more embodiments. FIG. 6A illustrates the process of FIG. 5 wherein the autonomous DFS Master performs the DFS scanning CAC phase 600 across multiple channels and upon completion of CAC phase, the autonomous DFS Master performs the ISM phase 601. During the ISM phase the DFS master transmits multiple beacons to indicate the availability of multiple DFS channels to nearby host and non-host (ordinary) access points and client devices, in accordance with one or more embodiments.

FIG. 6A shows the frequencies 602 and channels 603 that make up portions of the DFS 5 GHz Wi-Fi spectrum. U-NII-2A 606 covers the 5.25-5.35 GHz range. U-NII-2C 607 covers the 5.47-5.725 GHz range. The first channel to undergo CAC scanning is shown at element 607. The subsequent CAC scans of other channels are shown at elements 608. And the final CAC scan before the ISM phase 601 is shown at element 609.

In the ISM phase 601, the DFS master switches to the first channel in the whitelist. In the example in FIG. 6A, each channel 603 for which a CAC scan was performed was free of radar signals during the CAC scan and was added to the whitelist. Then the DFS master transmits 610 a DFS beacon on that channel. Then the DFS master scans 620 the first channel in the whitelist for the dwell time. Then the DFS master transmits 611 a beacon and scans 621 each of the other channels in the whitelist for the dwell time and then repeats starting 610 at the first channel in the whitelist in a round robin fashion for each respective channel. If a radar pattern is detected, the DFS master beacon for the respective channel is stopped, and the channel is marked in the blacklist and removed from the whitelist (and no longer ISM scanned).

FIG. 6A also shows an exemplary waveform 630 of the multiple beacon transmissions from the DFS master to indicate the availability of the multiple DFS channels to nearby host and non-host (ordinary) access points and client devices.

FIG. 6B illustrates a beacon transmission duty cycle 650 and a radar detection duty cycle 651. In this example, channel A is the first channel in a channel whitelist. In FIG. 6B, a beacon transmission in channel A 660 is followed by a quick scan of channel A 670. Next a beacon transmission in the second channel, channel B, 661 is followed by a quick scan of channel B 671. This sequence is repeated for channels C 662, 672; D 663, 673; E 664, 674; F 665, 675; G 666, 676, and H 667, 677. After the quick scan of channel H 677, the DFS master switches back to channel A and performs a second beacon transmission in channel A 660 followed by a second quick scan of channel A 670. The time between starting the first beacon transmission in channel A and starting the second beacon transmission in channel A is a beacon transmission duty cycle. The time between starting the first quick scan in channel A and starting the second quick scan in channel A is a radar detection duty cycle. In order to maintain connection with devices on a network, the beacon transmission duty cycle should be less than or equal to the maximum period between the beacons allowable for a client device to remain associated with the network.

An embodiment provides a standalone multi-channel DFS master that includes a beacon generator 212 to generate a beacon in each of a plurality of 5 GHz radio channels, a radar detector 211 to scan for a radar signal in each of the plurality of 5 GHz radio channels, a 5 GHz radio transceiver 215 to transmit the beacon in each of the plurality of 5 GHz radio channels and to receive the radar signal in each of the plurality of 5 GHz radio channels, and a fast channel switching generator 217 and embedded processor 203 coupled to the radar detector, the beacon generator, and the 5 GHz radio transceiver. The fast channel switching generator 217 and embedded processor 203 switch the 5 GHz radio transceiver 215 to a first channel of the plurality of 5 GHz radio channels and cause the beacon generator 212 to generate the beacon in the first channel of the plurality of 5 GHz radio channels. The fast channel switching generator 217 and embedded processor 203 also cause the radar detector 211 to scan for the radar signal in the first channel of the plurality of 5 GHz radio channels. The fast channel switching generator 217 and embedded processor 203 then repeat these steps for each of the other channels of the plurality of 5 GHz radio channels. The fast channel switching generator 217 and embedded processor 203 perform all of the steps for all of the plurality of 5 GHz radio channels during a beacon transmission duty cycle which is a time between successive beacon transmissions on a specific channel and, in some embodiments, a radar detection duty cycle which is a time between successive scans on the specific channel.

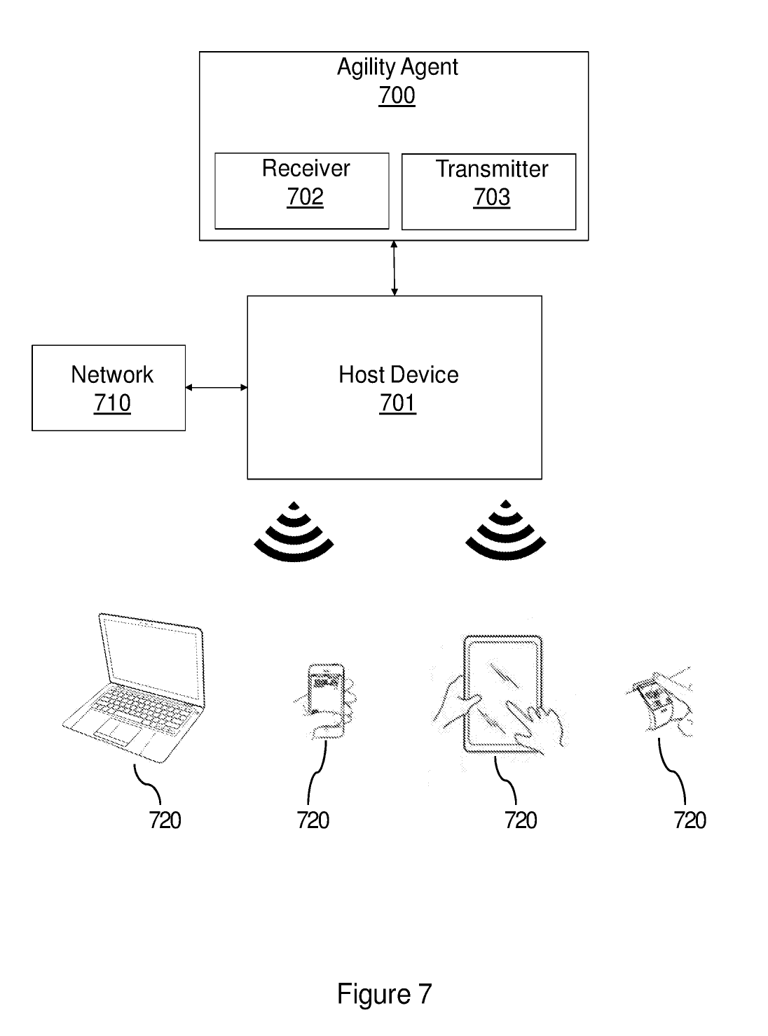

In the embodiment illustrated in FIG. 7, one or more embodiments include systems and methods for selecting available channels free of occupying signals from a plurality of radio frequency channels. The system includes an agility agent 700 functioning as an autonomous frequency selection master that has both an embedded radio receiver 702 to detect the occupying signals in each of the plurality of radio frequency channels and an embedded radio transmitter 703 to transmit an indication of the available channels and an indication of unavailable channels not free of the occupying signals. The agility agent 700 is programmed to connect to a host device 701 and control a selection of an operating channel selection of the host device by transmitting the indication of the available channels and the indication of the unavailable channels to the host device. The host device 701 communicates wirelessly with client devices 720 and acts as a gateway for client devices to a network 710 such as the Internet, other wide area network, or local area network. The host device 701, under the control of the agility agent 700, tells the client devices 720 which channel or channels to use for wireless communication. Additionally, the agility agent 700 may be programmed to transmit the indication of the available channels and the indication of the unavailable channels directly to client devices 720.

The agility agent 700 may operate in the 5 GHz band and the plurality of radio frequency channels may be in the 5 GHz band and the occupying signals are radar signals. The host device 701 may be a Wi-Fi access point or an LTE-U host device.

Further, the agility agent 700 may also be programmed to transmit the indication of the available channels by simultaneously transmitting multiple beacon signals. And the agility agent 700 may be programmed to transmit the indication of the available channels by transmitting a channel whitelist of the available channels and to transmit the indication of the unavailable channels by transmitting a channel blacklist of the unavailable channels. In addition to saving the channel in the channel blacklist, the agility agent 700 may also be programmed to determine and save in the channel blacklist information about the detected occupying signals including signal strength, traffic, and type of the occupying signals.

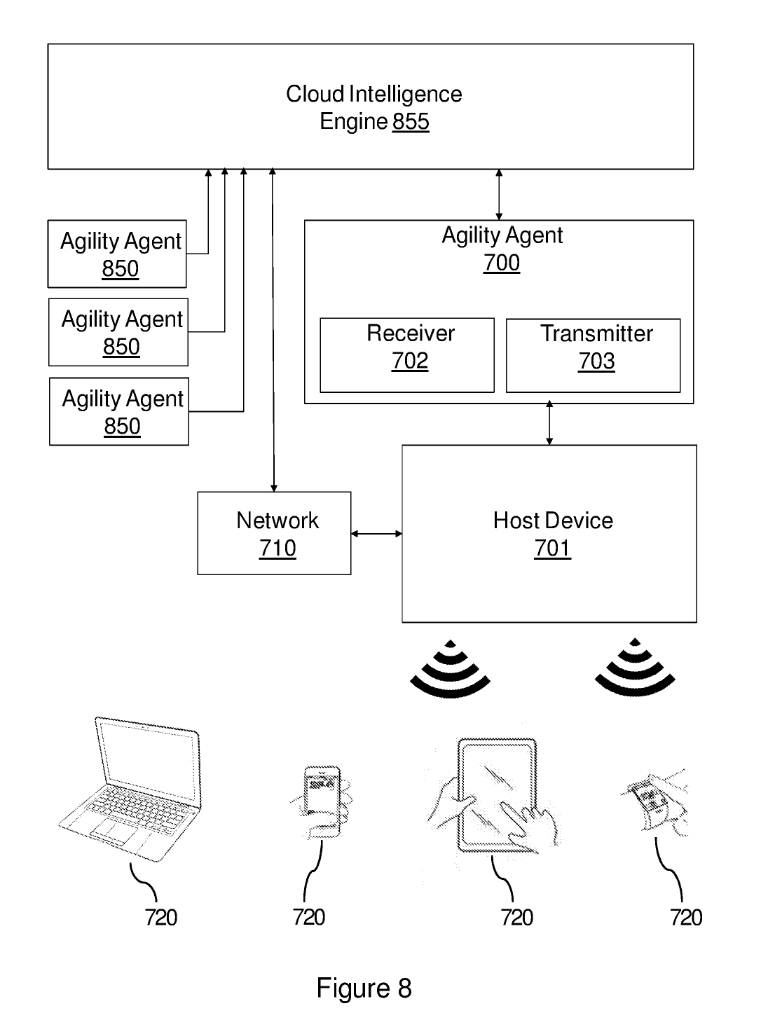

As shown in FIG. 8, in some embodiments, the agility agent 700 is connected to a cloud-based intelligence engine 855. The agility agent 700 may connect to the cloud intelligence engine 855 directly or through the host device 701 and network 710. The cloud intelligence engine 855 integrates time distributed information from the agility agent 700 and combines information from a plurality of other agility agents 850 distributed in space and connected to the cloud intelligence engine 855. The agility agent 700 is programmed to receive control and coordination signals and authorized and preferred channel selection guidance information from the cloud intelligence engine 755.

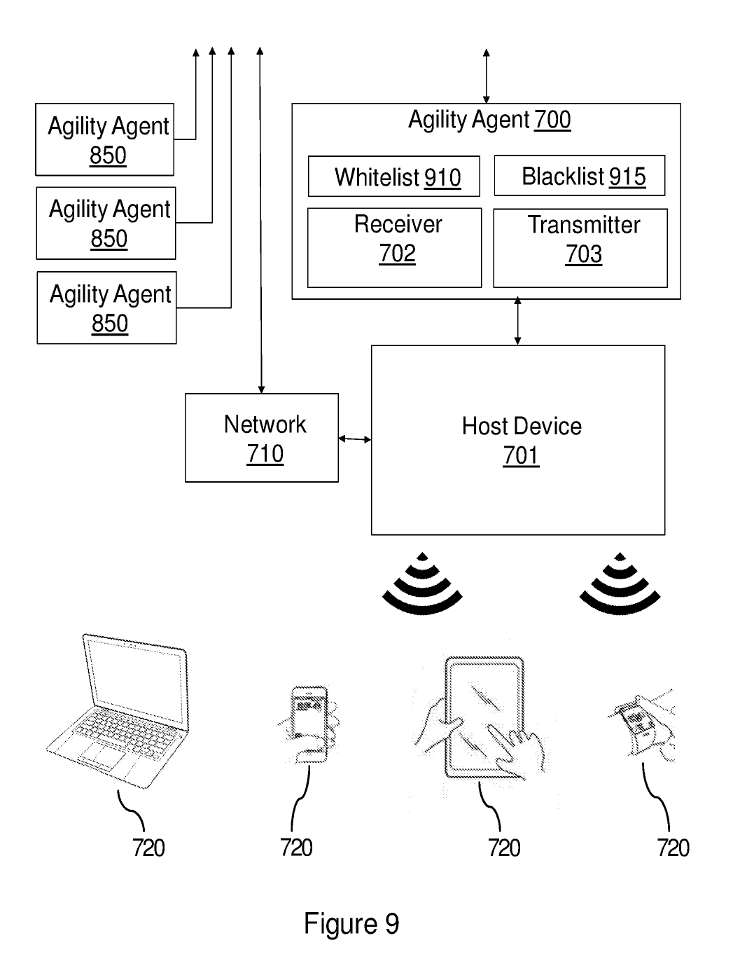

In another embodiment shown in FIG. 9, the one or more embodiments include a system and method for selecting available channels free of occupying signals from a plurality of radio frequency channels in which an agility agent 700 functioning as an autonomous frequency selection master includes an embedded radio receiver 702 to detect the occupying signals in each of the plurality of radio frequency channels and an embedded radio transmitter 703 to indicate the available channels and unavailable channels not free of the occupying signals. The agility agent 700 contains a channel whitelist 910 of one or more channels scanned and determined not to contain an occupying signal. The agility agent 700 may receive the whitelist 910 from another device including a cloud intelligence engine 855. Or the agility agent 700 may have previously derived the whitelist 910 through a continuous CAC for one or more channels. In this embodiment, the agility agent 700 is programmed to cause the embedded radio receiver 702 to scan each of the plurality of radio frequency channels non-continuously interspersed with periodic switching to the channels in the channel whitelist 910 to perform a quick occupying signal scan in each channel in the channel whitelist 910. The agility agent 700 is further programmed to cause the embedded radio transmitter 703 to transmit a first beacon transmission in each channel in the channel whitelist 910 during the quick occupying signal scan and to track in the channel whitelist 910 the channels scanned and determined not to contain the occupying signal during the non-continuous scan and the quick occupying signal scan. The agility agent 700 is also programmed to track in a channel blacklist 915 the channels scanned and determined to contain the occupying signal during the non-continuous scan and the quick occupying signal scan and then to perform in-service monitoring for the occupying signal, including transmitting a second beacon for each of the channels in the channel whitelist 910, continuously and sequentially.

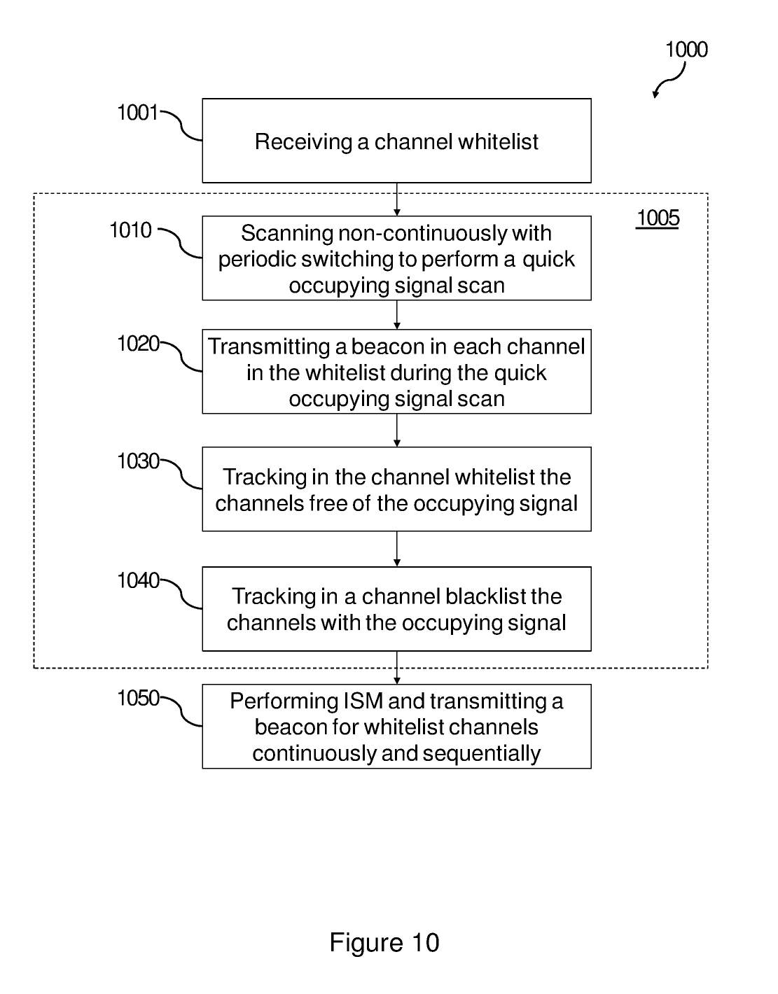

FIG. 10 illustrates an exemplary method 1000 according to one or more embodiments for selecting an operating channel from a plurality of radio frequency channels in an agility agent functioning as an autonomous frequency selection master. The method includes receiving a channel whitelist of one or more channels scanned and determined not to contain an occupying signal 1010. Next, the agility agent performs a channel availability check 1005 for the plurality of radio frequency channels in a time-division manner. The time-division channel availability check includes scanning 1010 with an embedded radio receiver in the agility agent each of the plurality of radio frequency channels non-continuously interspersed with periodic switching to the channels in the channel whitelist to perform a quick occupying signal scan and transmitting 1020 a first beacon with an embedded radio transmitter in the agility agent in each channel in the channel whitelist during the quick occupying signal scan. The agility agent also tracks 1030 in the channel whitelist the channels scanned in step 1010 and determined not to contain the occupying signal and tracks 1040 in a channel blacklist the channels scanned in step 1010 and determined to contain the occupying signal. Finally, the agility agent performs in-service monitoring for the occupying signal and a second beaconing transmission for each of the channels in the channel whitelist continuously and sequentially 1050.

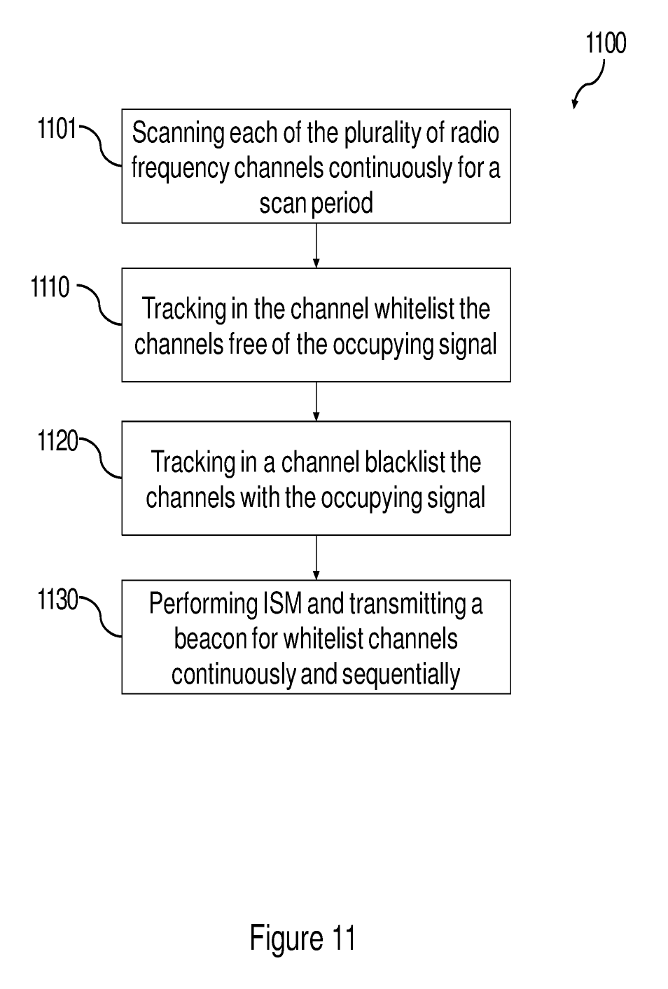

FIG. 11 illustrates another exemplary method 1100 for selecting an operating channel from a plurality of radio frequency channels in an agility agent functioning as an autonomous frequency selection master. The method 1100 includes performing a channel availability check for each of the plurality of radio frequency channels by scanning 1101 with an embedded radio receiver in the agility agent each of the plurality of radio frequency channels continuously for a scan period. The agility agent then tracks 1110 in a channel whitelist the channels scanned and determined not to contain an occupying signal and tracks 1120 in a channel blacklist the channels scanned and determined to contain the occupying signal. Then the agility agent performs in-service monitoring for the occupying signal and transmits a beacon with an embedded radio transmitter in the agility agent for each of the channels in the channel whitelist continuously and sequentially 1130.

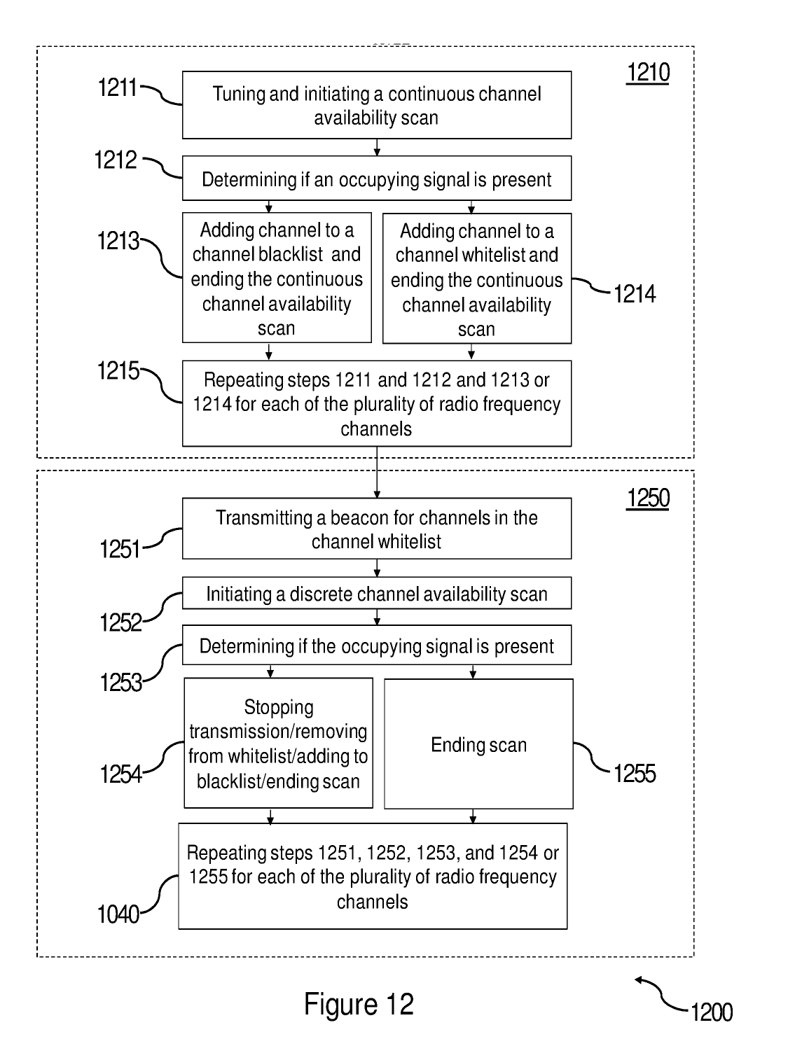

FIG. 12 illustrates a further exemplary method 1200 for selecting an operating channel from a plurality of radio frequency channels in an agility agent functioning as an autonomous frequency selection master. The method 1200 includes performing a channel availability check 1210 for each of the plurality of radio frequency channels and performing in-service monitoring and beaconing 1250 for each of the plurality of radio frequency channels. The channel availability check 1210 includes tuning an embedded radio receiver in the autonomous frequency selection master device to one of the plurality of radio frequency channels and initiating a continuous channel availability scan in the one of the plurality of radio frequency channels with the embedded radio receiver 1211. Next, the channel availability check 1210 includes determining if an occupying signal is present in the one of the plurality of radio frequency channels during the continuous channel availability scan 1212. If the occupying signal is present in the one of the plurality of radio frequency channels during the continuous channel availability scan, the channel availability check 1210 includes adding the one of the plurality of radio frequency channels to a channel blacklist and ending the continuous channel availability scan 1213. If the occupying signal is not present in the one of the plurality of radio frequency channels during the continuous channel availability scan during a first scan period, the channel availability check 1210 includes adding the one of the plurality of radio frequency channels to a channel whitelist and ending the continuous channel availability scan 1214. Next, the channel availability check 1210 includes repeating steps 1211 and 1212 and either 1213 or 1214 for each of the plurality of radio frequency channels.

The in-service monitoring and beaconing 1250 for each of the plurality of radio frequency channels includes determining if the one of the plurality of radio frequency channels is in the channel whitelist and if so, tuning the embedded radio receiver in the autonomous frequency selection master device to the one of the plurality of radio frequency channels and transmitting a beacon in the one of the plurality of radio frequency channels with an embedded radio transmitter in the autonomous frequency selection master device 1251. Next, the in-service monitoring and beaconing 1250 includes initiating a discrete channel availability scan (a quick scan as described previously) in the one of the plurality of radio frequency channels with the embedded radio receiver 1252. Next, the in-service monitoring and beaconing 1250 includes determining if the occupying signal is present in the one of the plurality of radio frequency channels during the discrete channel availability scan 1253. If the occupying signal is present, the in-service monitoring and beaconing 1250 includes stopping transmission of the beacon, removing the one of the plurality of radio frequency channels from the channel whitelist, adding the one of the plurality of radio frequency channels to the channel blacklist, and ending the discrete channel availability scan 1254. If the occupying signal is not present in the one of the plurality of radio frequency channels during the discrete channel availability scan for a second scan period, the in-service monitoring and beaconing 1250 includes ending the discrete channel availability scan 1255. Thereafter, the in-service monitoring and beaconing 1250 includes repeating steps 1251, 1252, and 1253 as well as either 1254 or 1255 for each of the plurality of radio frequency channels.

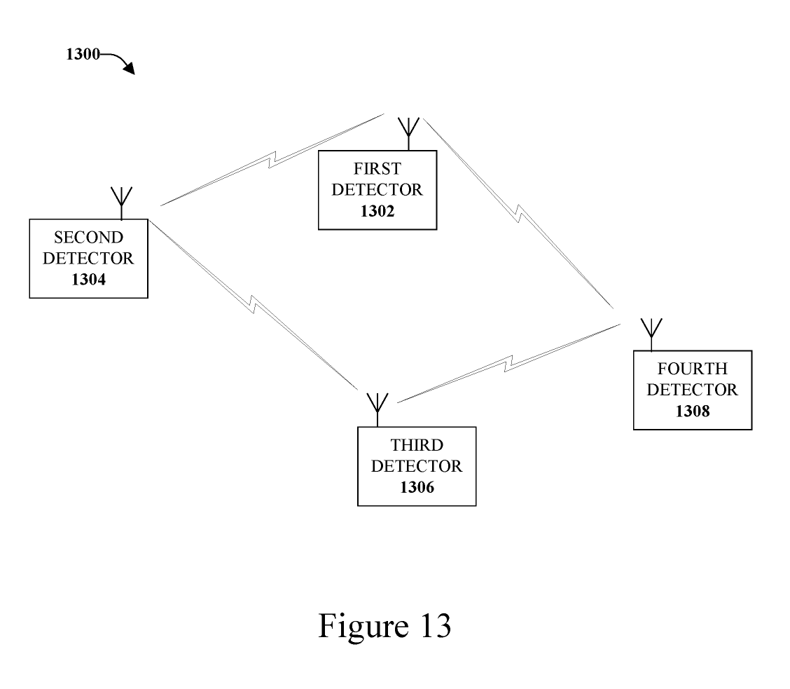

FIG. 13 illustrates an example, non-limiting network 1300 that provides multiple detector coordination for monitoring of multiple channels in a dynamic frequency selection band accordance with one or more embodiments described herein. The network 1300 can include a network array of detectors, illustrated as a first detector 1302, a second detector 1304, a third detector 1306, and a fourth detector 1308, which are communicatively coupled together. Although only four detectors are shown and described with respect to the following description, there could be any number of detectors included in the network array of detectors.

In an example, the network array of detectors can be a network array of access points. Thus, the first detector 1302 can be a first access point, the second detector 1304 can be a second access point, the third detector 1306 can be a third access point, and the fourth detector 1308 can be a fourth access point, and so on. For this example, the access points are limited and can detect one channel at a time. Further to this example, each access point is capable of performing DFS detection. Therefore, the first detector 1302 can scan a first DFS channel for radar, the second detector 1304 can scan a second DFS channel for radar, the third detector 1306 can scan a third DFS channel for radar, the fourth detector 1308 can scan a fourth DFS channel for radar, and so on.

Continuing the example, the first detector 1302 scans channel 100 and determines no radar is detected on channel 100. Thus, the first detector 1302 communicates to the other detectors that it is monitoring channel 100 and the other detectors do not need to monitor that channel. Further, the second detector 1304 scans channel 116 and determines there is no radar on channel 116. The second detector 1304 can communicate the information related to channel 116 to the other detectors. Based on this information, the first detector 1302 and the second detector 1304 each have a whitelist that includes channel 100 and channel 116. Further, this information can be communicated to the third detector 1306 and the fourth detector 1308. Thus, all the detectors have a whitelist (or a blacklist) of the channels that have been scanned and are being monitored. In such a manner, the network array of detectors are coordinating and sharing information in the network 1300. Accordingly, this coordination system can be between independent access points in the network, which can be sharing information and each access point (or detector) is monitoring different channels. Further, the detectors can be in proximity to each other (e.g., close together) such that the detectors are able to coordinate the information. It is noted that detectors in proximity to each other can provide some degree of overlapping radar detector coverage.

In another example, the first detector 1302 can be a DFS master device and the other detectors can be access points with limited DFS capability. Capabilities (e.g., software capabilities) of the DFS master device can coordinate communication and information sharing between detectors of the network array of detectors. For example, the first detector 1302 (e.g., the DFS master device) can perform an autonomous channel availability check (CAC) to determine if a DFS channel contains radar or does not contain radar. If radar is detected on a channel, information related to that channel is included in a blacklist. Alternatively, if radar is not detected on a channel, information related to that channel is included in a whitelist. The blacklist and/or the whitelist can be communicated to the other detectors (e.g., the access points in this example). Thus, the CAC is performed autonomously on the DFS master device and the in-service monitoring can be performed by the access points. Accordingly, if the DFS master device determines no radar was detected on channel 100 and channel 116, the information related to channels 100 and 116 can be included in a whitelist, which is communicated to the access points. A first access point may select channel 100 and assumes responsibility for in-service monitoring of channel 100 and a second access point may select channel 116 and assume responsibility for in-service monitoring of channel 116. The first and second access point communicate respective information to the DFS master device indicating that the in-service monitoring will be performed by the access points. Based on the received information, the DFS master device discontinues monitoring of channel 100 and channel 116 and performs a CAC on another channel. If during the in-service monitoring a access point detects radar on the channel, the DFS master device is notified and another channel included in the whitelist can be selected by the access point for networking and the access point can takeover in-service monitoring of the selected channel.

Therefore, the multiple detectors are coordinating and distributing in-service monitoring tasks. One DFS master can perform the CAC and can immediately (or at a later time) hand off the ISM task to a target access point that can operate a network on that channel. The target access point can handle the duty of ISM to free the DFS master to prepare (e.g., CAC) other channels. The target access point gains the benefit of being able to start a network on a non-DFS channel until a DFS channel is available. Further details will be provided with respect to the following figures.

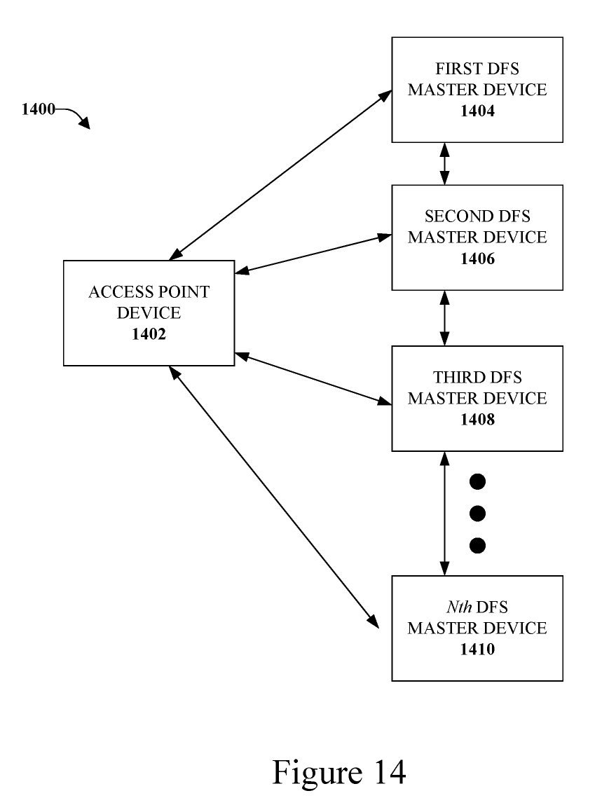

FIG. 14 illustrates an example, non-limiting system 1400 that can perform soft handover of dynamic frequency selection functionalities in accordance with one or more embodiments described herein. The system 1400 can perform the soft handover so that client devices will not experience network downtime due to the need to wait for a channel availability check (CAC).

The system can include an access point device 1402 that can be communicatively coupled to one or more other devices, which can be agility agents, as discussed herein. In FIG. 14, these devices are illustrated as dynamic frequency selection (DFS) master devices. According to some implementations, the access point device 1402 can be a native access point device. In accordance with some implementations, the access point device 1402 can be a access point. Further, the access point device 1402 can be servicing a client. The term “coupled” or variants thereof can include various communications including, but not limited to, direct communications, indirect communications, wired communications, and/or wireless communications.

The DFS master devices are illustrated as a first DFS master device 1404, a second DFS master device 1406, a third DFS master device 1408, and an N DFS Master device 1410, where N can be an integer. It is noted that while a particular number of DFS master devices are illustrated and described, the disclosed aspects are not limited to this implementation. Instead, any number of DFS master devices can be utilized in the system 1400 and/or other systems. For example, some implementations can utilize a single DFS master device while other implementations can utilize two or more DFS master devices. One or more of the DFS master devices can be autonomous/standalone radar detector devices, non-stand alone radar detector devices, or combinations thereof. The communication coordination between the access point device 1402 and the multiple DFS master devices can be direct communications. According to some implementations, the communication coordination can be indirect, such as by way of a Cloud network or another type of network.

As previously discussed herein, a single device can perform channel availability check (CAC) and in-service monitoring (ISM) of various channels. However, according to the implementation of FIG. 14 and the following figures, the CAC DFS functionality and the ISM DFS functionality can be divided between the access point device 1402 and the one or more DFS master devices. The access point device 1402 does not perform CAC according to the various aspects provided herein. Instead, the one or more DFS master devices perform the CAC and provide the results to the access point device 1402. Thus, according to these implementations, the one or more DFS master devices can report the DFS channel information to the access point device 1402. The access point device 1402 can operate on a non-DFS channel until a DFS channel becomes available.

Each of the first DFS master device 1404, the second DFS master device 1406, the third DFS master device 1408, and the N DFS master device 1410 can include respective beacon generators, respective radar detectors, respective 5 GHz radio transceivers, respective switches and respective processors coupled to the respective radar detectors. For purposes of simplicity, the following will be discussed with respect to the first DFS master device 1404, however, this discussion can be also applied to the other DFS master devices.

The beacon generator can generate a first beacon in a first 5 GHz radio channel. The first 5 GHz radio channel can be selected from a plurality of 5 GHz radio channels. The radar detector can scan for a first radar signal in the first 5 GHz radio channel. Further, the 5 GHz radio transceiver can transmit the first beacon in the first 5 GHz radio channel and can receive the first radar signal in the first 5 GHz radio channel.

The sensor and the embedded processor can communicate to the access point device 1402 information related to the first 5 GHz radio channel. For example, the communication to the access point device 1402 can include information that the first 5 GHz radio channel is available for use based on a first determination that the first 5 GHz radio channel does not comprise the first radar signal. Further, the sensor and the embedded processor can perform a soft handover of DFS functionalities to the access point device 1402. According to an implementation, the DFS functionalities comprise continuous ISM of the first 5 GHz radio channel. Further to this implementation, the radar detector, the beacon generator, and the 5 GHz radio transceiver discontinue continuous in-service monitoring of the first 5 GHz radio channel.

For example, based on a determination that the first 5 GHz radio channel does not contain the first radar signal, data related to the first 5 GHz radio channel can be retained in a whitelist, which can be stored in respective memories of the DFS master devices. The whitelist can also include respective data related to other 5 GHz radio channels determined to be available for use (e.g., no radar signal detected). The data related to the first 5 GHz radio channel (as well as data related to other 5 GHz radio channels included in the whitelist) can be reported to the access point device 1402. For example, based on the determination that a radar signal was not detected on the first 5 GHz channel, the access point device 1402 can immediately begin to use the first 5 GHz channel and, at substantially the same time, begin continuous in-service monitoring of the access channel. Accordingly, time can be saved at the access point device 1402 by eliminating the need for the access point device 1402 to perform CAC and/or to wait for the CAC to be conducted by another device.

At about the same time as the access point device 1402 begins the continuous in-service monitoring, the access point device can provide a confirmation to the one or more DFS master devices. The confirmation can confirm that the access point device 1402 has assumed in-service monitoring of the first 5 GHz radio channel. Based upon the confirmation, the beacon generator and the 5 GHz radio transceiver can discontinue the continuous in-service monitoring of the first 5 GHz radio channel. In this manner, the first DFS master device no longer needs to monitor the first 5 GHz radio channel, thus conserving resources.

According to various implementations, at about the same time as the confirmation is received from the access point device 1402, the first DFS master device 1404 can perform a CAC on a second 5 GHz radio channel. For example, the beacon generator can generate a second beacon in the second 5 GHz radio channel selected from the plurality of 5 GHz radio channels. The radar detector can scan a second radar signal in the second 5 GHz radio channel. Further, the radio transceiver can transmit the second beacon in the second 5 GHz radio channel and can receive the second radar signal in the second 5 GHz radio channel. Based on a determination that the radar signal was not detected in the second 5 GHz radio channel, data related to the second 5 GHz radio channel can be included in the whitelist. Further, the access point device 1402 (and/or other access point devices) can be informed that the second 5 GHz radio channel is available for use. The DFS master device can perform ISM on the second 5 GHz radio channel if no access point device is using/monitoring the channel. Thus, the DFS master device can keep the second 5 GHz radio channel in standby (e.g., as a backup channel). At about the same time as radar is detected by the access point device on the first 5 GHz radio channel, the access point device notifies the DFS master device, which provides information related to the second 5 GHz radio channel, or another 5 GHz radio channel on which no radar is detected.

According to some implementations, radar signals may be detected on the first 5 GHz radio channel, the second 5 GHz radio channel, and/or a subsequent 5 GHz radio channel. The radar signal indicates the particular 5 GHz radio channel is in use and, therefore, cannot be used by the access point device 1402 for networking. In this case information related to the particular channel is included in a blacklist, which can be saved in the memory. Over time, one of the DFS master devices may perform another CAC on the 5 GHz radio channels included in the blacklist to determine if any of those channels can be now available for use by the access point device 1402.

During the continuous in-service monitoring of the first 5 GHz radio channel, the access point device 1402 may detect radar. Based on this detection, the access point device 1402 notifies the first DFS master device 1404 (or another DFS master device), which includes data related to the first 5 GHz channel in the blacklist. The access point device 1402 may select another 5 GHz channel from the whitelist (provided another access point is not using that channel). The first DFS master device 1404 (or another DFS master device) may perform another CAC on the first 5 GHz channel to determine when/if that channel is available for network use.

In accordance with some implementations, the access point device 1402 may go out of service and, therefore, can no longer perform continuous in-service monitoring of the first 5 GHz channel (or another 5 GHz channel). For example, the access point device 1402 may go out of service due to a configuration change, a restart (e.g., a driver restart), and so on. In these cases, the access point device 1402 may return control on continuous in-service monitoring of the channel to the first DFS master device (or another master device). Thus, the DFS master device can perform the in-service monitoring of the channel until the access point device 1402 can resume the continuous in-service monitoring.

As illustrated, the system 1400 can include one or more DFS master devices. The one or more DFS master devices can be responsible for handling DFS functionalities for a wireless service provider device, such as an access point device's operating channels. Further, the one or more DFS master devices can be responsible for handling the DFS functionalities for the wireless service provider, such as an access point device's backup channels.

The access point device can ask one or more DFS master devices to dynamically take over the DFS functionalities on the access point device's operating channels while the access point device shuts off its radio, performs configuration changes, and then resumes its radio on the channels that were being handled by the DFS master devices without waiting for or re-doing the channel availability check. While the access point device is performing its own DFS master functionality, such as in-service monitoring, the secondary and other DFS master devices can perform channel availability check on backup channels.

Once the secondary DFS master device finishes CAC on the backup channels, the access point device can move to (e.g. operate in) any of the backup channels without waiting for the CAC and immediately start in-service monitoring. At about the same time as the access point device moves to the new channel and immediately (or almost immediately) starts ISM, the secondary DFS Masters can immediately (or almost immediately) move and perform CAC on the backup channels.

If the access point device needs to interrupt its ISM on its operating channels, the access point device can inform the secondary DFS master devices to take over ISM on the access point device's operating channels. Once the access point device is ready to take over ISM, it can inform the secondary DFS master devices to move to backup channels.

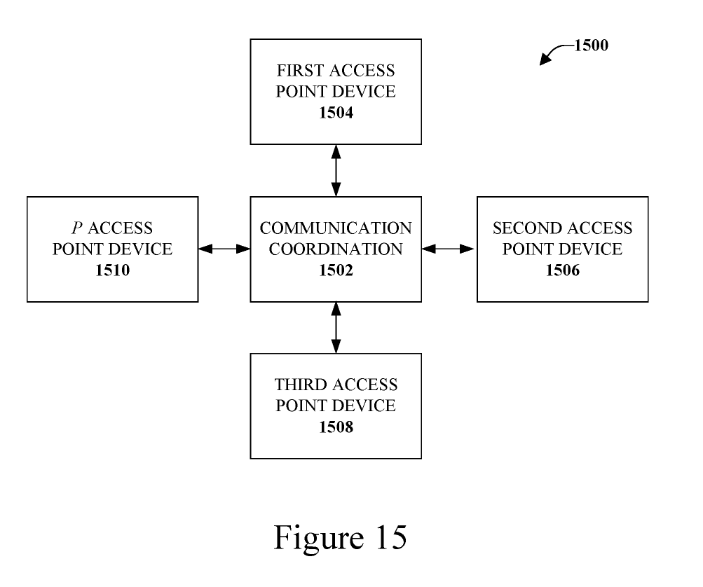

FIG. 15 illustrates an example, non-limiting system 1500 that includes multiple access point devices, wherein respective DFS functionalities can be handed over to one or more access point devices in accordance with one or more embodiments described herein. According to some implementations, multiple access points may be utilized with the disclosed aspects. For example, one or more DFS master devices (e.g., first DFS master device 1404, second DFS master device 1406, third DFS master device 1408, and/or N DFS master device 1410 of FIG. 14) may communicate with one or more access points.

For example, a communication between the one or more DFS master devices and the one or more access points may be facilitated through communication coordination 1502. The communication coordination 1502 can monitor or keep track of the whitelist and/or blacklist created by the one or more DFS master devices. It is noted that the DFS master devices are not illustrated in FIG. 15 for purposes of simplicity. The communication coordination 1502 can be software coordination according to some aspects. The communication coordination 1502 can occur through a wide-area cloud-based network or another wired or wireless local communication network. According to some implementation, the communication coordination 1042 can be located, at least partially, on one or more access points.

Illustrated are a first access point device 1504, a second access point device 1506, a third access point device 1508, and a P access point device 1510, where P is an integer. Although multiple access point devices are illustrated, in various aspects a single access point may be utilized; in other cases two or more access point devices can be utilized. Further, in some implementations, one or more DFS master devices and/or one or more access point devices can be utilized.

Each access point or access point device can have limited DFS capability. For example, in some implementations one or more access point devices may only have the capability to watch a single channel at a time. Thus, in these implementations, when an access point is performing continuous in-service monitoring of a channel, as discussed herein, the DFS master device performs the ISM on the other channel. However, in the case where there is more than one access point device, each access point device can perform respective continuous ISM of their assigned channel, relieving the DFS master device of the responsibility to perform continuous ISM of those channels.

In an example, non-limiting use case scenario, a DFS master device may perform a CAC on a first 5 GHz channel and assign the first 5 GHz channel to the first access point device 1504 based on a determination that the first 5 GHz channel is available for networking. The first access point device 1504 can provide an acknowledgement that the first access point device 1504 has commenced continuous in-service monitoring of the first 5 GHz channel. Based on this acknowledgement, the DFS master device can discontinue monitoring the first 5 GHz channel and can perform a CAC on a second 5 GHz channel. The second 5 GHz channel can be assigned to the second access point device 1506 based on a determination that radar was not detected on the second 5 GHz channel. The second access point device 1506 can acknowledge that it has commenced continuous in-service monitoring of the second 5 GHz channel, and the DFS master device can discontinue its monitoring the second 5 GHz channel. The DFS master device can perform a CAC on the third 5 GHz channel and/or P 5 GHz channel, transferring the continuous in-service monitoring of those channels to the respective access points. If one of the channels is determined to contain radar, that channel is placed on the blacklist and the next available channel can be assigned to the next access point device. For example, if radar is detected on a third 5 GHz channel, but no radar is detected on a fourth 5 GHz channel, the fourth 5 GHz channel can be assigned to the third access point device, and so on.

In this type of system, an access point device can try to avoid overlap of the channels in order to reduce interference. However, since each access point device is responsible for the continuous ISM of the channel assigned, the DFS master device can stop monitoring and perform a CAC on a next channel. In such a manner, the ISM can be handed off (e.g., a soft handoff) to the access point devices while the DFS master device acquires more channels and/or radar information related to those channels. Accordingly, the access point devices assist the DFS master device by assuming responsibility of the continuous ISM of at least some of the channels.

In a non-limiting example, the first access point device 1504 can watch/monitor radar for Channel A, which is a DFS channel. The second access point device 1506 can watch/monitor radar for Channel B, which is another DFS channel. The third access point device 1508 can watch monitor radar for Channel C, which can be a DFS channel. Further, P access point device 1510 can monitor Channel P, which can be a DFS channel.

According to some implementations, the access point devices (e.g., first access point device 1504, second access point device 1506, third access point device 1508, and P access point device 1510) can be located in close proximity of each other. The proximity can be defined based on geographic location. For example, the access point devices that utilize the same communication coordination 1502 can be located in the same apartment building. The proximity of the access point devices may be utilized so that each access point device is affected by the same radar. For example, if the first access point device 1504 detects radar, the second access point device 1506, the third access point device 1508, and the P access point device 1510 also experience the radar.

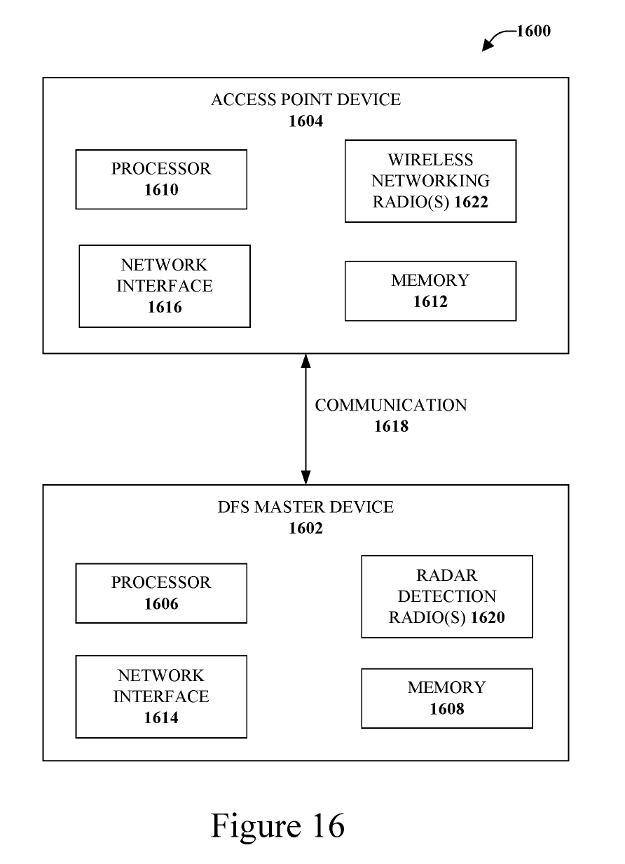

FIG. 16 illustrates an example, non-limiting system 1600 for handover of dynamic frequency selection functionalities in accordance with one or more embodiments described herein. Illustrated in the system 1600 are a DFS master device 1602 and an access point device 1604. Although a single DFS master device 1602 and a single access point device 1604 are illustrated, various implementations may include two or more DFS master devices and/or two or more access points.

The DFS master device 1602 can include at least one processor 1606 (or a microprocessor) and at least one memory 1608. The at least one processor 1606 can be communicatively coupled to the at least one memory 1608. Further, the at least one processor 1606 can facilitate execution of the computer executable components and/or the computer executable instructions stored in the memory 1608. The access point device 1604 can include at least one processor 1610 (or a microprocessor) and at least one memory 1612. The at least one memory 1612, can store computer executable components and/or computer executable instructions. The at least one processor 1610 can be communicatively coupled to the at least one memory 1612 and can facilitate execution of the computer executable components and/or the computer executable instructions stored in the memory 1612. The term “coupled” or variants thereof can include various communications including, but not limited to, direct communications, indirect communications, wired communications, and/or wireless communications.

It is noted that although the one or more computer executable components and/or computer executable instructions may be illustrated and described herein as components and/or instructions separate from the memory 1608 and/or the memory 1612 (e.g., operatively connected to the memory 1608 and/or the memory 1612), the various aspects are not limited to this implementation. Instead, in accordance with various implementations, the one or more computer executable components and/or the one or more computer executable instructions may be stored in (or integrated within) the memory 1608 and/or the memory 1612. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

The DFS master device 1602 and the access point device 1604 may include respective network interfaces 1614 and 1616. The respective network interfaces 1614 and 1616 can perform various network functions including, but not limited to, CAC and/or ISM as discussed herein. Further, the respective network interfaces 1614 and 1616 can facilitate communication 1618 (e.g., communication coordination) between the DFS master device 1602 and the access point device 1604.

The DFS master device 1602 can include one or more radar detection radios 1620. The one or more radar detection radios 1620 can detect radar on one or more DFS channels, as discussed herein. The access point device 1604 can include one or more wireless networking radios 1622, which will be described below with reference to the following figure.

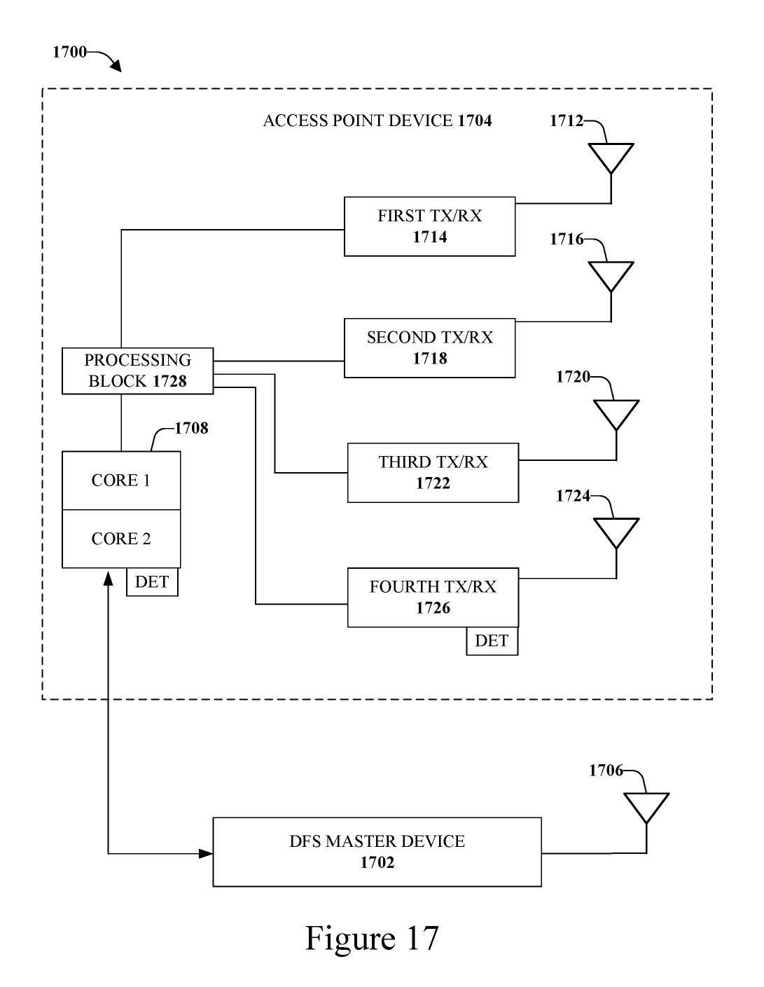

FIG. 17 illustrates an example, non-limiting system 1700 for continuous in-service monitoring of a 5 GHz radio channel by an access point after a channel availability check has been performed on the 5 GHz radio channel, the access point can include multiple antennas and a central processing unit in accordance with one or more embodiments described herein. The system 1700 can include a DFS master radar detector 1702 and an access point device 1704. The DFS master radar detector 1702 can be integrated inside the system 1700 or external to the system 1700 as a standalone DFS master. For example, the DFS master radar detector 1702 can be external to the networking circuitry of the access point device 1704 and can use its own antenna 1706 and processor (not shown). According to other implementations, the DFS master radar detector 1702 can share or multiplex some circuitry used by the access point device 1704 for networking. The DFS Master radar detector 1702 can include at least one radar detector antenna 1706.

The access point device 1704 can include a central processing unit (CPU 1708), for example, that can include one or more cores. The CPU 1708 can receive an indication from the DFS master radar detector 1702 that one or more 5 GHz channels are available for use by the access point device 1704 for networking functions.

As illustrated, the access point device 1704 can include multiple antennas, such as the four antennas illustrated. However, the access point device 1704 can include fewer or more antennas than four according to various aspects. As illustrated, a first antenna 1712 can be operatively connected to a first transmitter/receiver 1714, and a second antenna 1716 can be operatively connected to a second transmitter/receiver 1718. Further, a third antenna 1720 can be operatively connected to a third transmitter/receiver 1722; a fourth antenna 1724 can be operatively connected to a fourth transmitter/receiver 1726. The first transmitter/receiver 1714, the second transmitter/receiver 1718, the third transmitter/receiver 1722, and the fourth transmitter/receiver 1726 can be operatively connected to a wireless processing block 1728, which can be coupled to the CPU 1708. The wireless processing block 1728 can be a component that processes the transmit/receive streams from the transmitter/receivers into a coherent data stream to be processed by the CPU 1708. According to some implementations, all four antennas, or a subset thereof, can be utilized for ISM monitoring.

As mentioned above, in some implementations, the DFS master radar detector 1702 can share or multiplex at least a portion of the circuitry used by the access point device 1704 for networking. According to an example, the sharing or multiplexing can be performed by partitioning the access point device 1704 to use a dedicated CPU core (homogenous or heterogeneous CPU design) and/or a virtualized CPU with dedicated processing resources (dedicated MIPS, Virtualized I/O and interrupts) and/or using one or more wireless networking radios for radar monitoring of different frequency/frequencies than the current networking frequency.

According to another example, the sharing or multiplexing can be performed by operating the access point device CPU (virtual or otherwise) resource on dedicated memory or using securely partitioned memory carved out from the main memory (giving it the appearance of dedicated memory).

In another example, the sharing or multiplexing can be performed by running a separate RTOS/OS/Executive on the dedicated CPU resource (real or virtual) and memory (dedicated or partitioned). This processing subsystem can run the required algorithms, and signal processing for a dedicated multi-channel zero-wait DFS. Isolated from the main processor and memory with the appearance of being “standalone.”

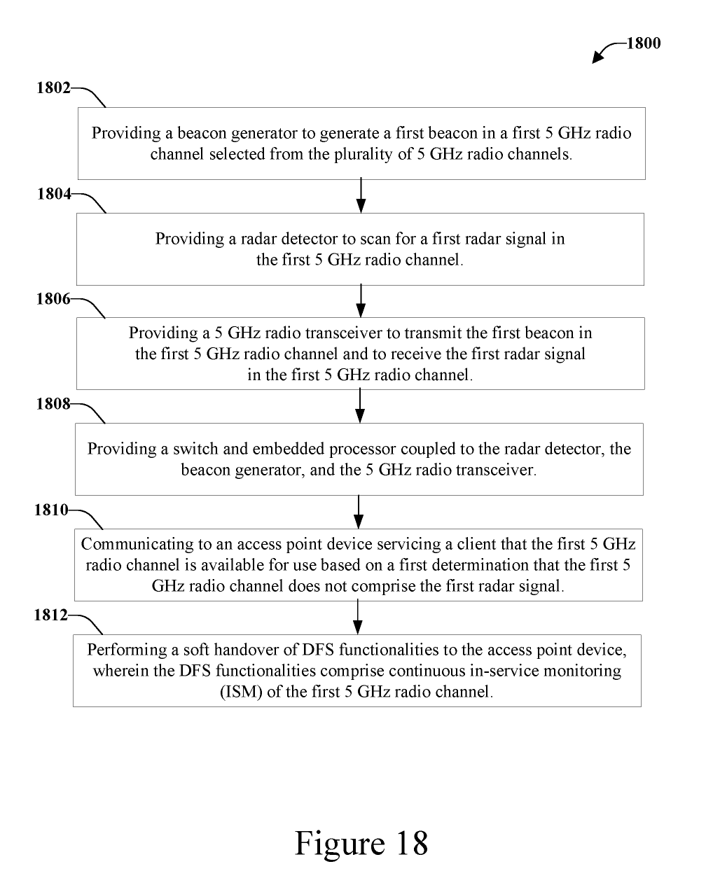

FIG. 18 illustrates an example, non-limiting flow chart 1800 for in-service monitoring of available dynamic frequency selection (DFS) channels free of radar signals selected from a plurality of 5 GHz radio frequency channels in accordance with one or more embodiments described herein. The method 1800 in FIG. 18 can be implemented using, for example, any of the systems, such as a system 1400 (of FIG. 14), described herein.

The method 1800 start at 1802 with providing a beacon generator to generate a first beacon in a first 5 GHz radio channel selected from the plurality of 5 GHz radio channels. At 1804, a radar detector is provided to scan for a first radar signal in the first 5 GHz radio channel. Further, at 1806, a 5 GHz radio transceiver is provided to transmit the first beacon in the first 5 GHz radio channel and to receive the first radar signal in the first 5 GHz radio channel. The method 1800 continues at 1808 with providing a switch and embedded processor coupled to the radar detector, the beacon generator, and the 5 GHz radio transceiver.

With the switch and the embedded processor, at 1810, the method 1800 includes communicating to an access point device servicing a client that the first 5 GHz radio channel is available for use based on a first determination that the first 5 GHz radio channel does not comprise the first radar signal. The method 1800 continues at 1812 with performing a soft handover of DFS functionalities to the access point device. The DFS functionalities can comprise continuous in-service monitoring (ISM) of the first 5 GHz radio channel. The radar detector, the beacon generator, and the 5 GHz radio transceiver can discontinue continuous in-service monitoring of the first 5 GHz radio channel.

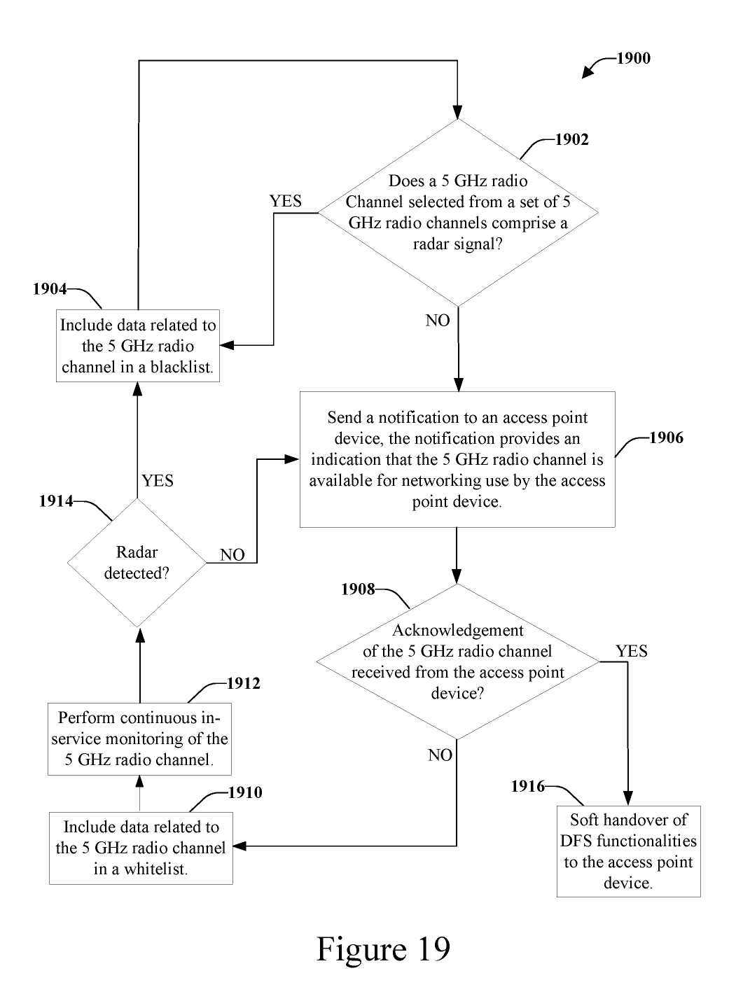

FIG. 19 illustrates an example, non-limiting flow chart 1900 for soft handoff of continuous service monitoring of a dynamic frequency selection channel in accordance with one or more embodiments described herein. The method 1900 in FIG. 19 can be implemented using, for example, any of the systems, such as a system 1500 (of FIG. 15), described herein.

At 1902, a determination is made whether a first 5 GHz radio channel selected from a set of 5 GHz radio channels comprises a radar signal. If the first 5 GHz radio channel does contain a radar signal (“YES”), at 1904 data related to the first 5 GHz radio channel can be included in a blacklist. The first 5 GHz radio channel (as well as other channels included in the blacklist) can be periodically checked, at 1902, to determine whether the channel no longer contains a radar signal.

If the determination, at 1902, is that the channel does not contain the radar signal (“NO”), at 1906, a notification is sent to an access point device. The notification provides an indication that the first 5 GHz radio channel is available for networking use by the access point device.

The method 1900 continues, at 1908, when a determination is made whether an acknowledgement of the first 5 GHz radio channel has been received from the access point device. The acknowledgement can include a confirmation that the access point device has commenced continuous in-service monitoring of the first 5 GHz radio channel.

If the determination, at 1908, is that an acknowledgement has not been received (“NO”), at 1910, data related to the first 5 GHz radio channel can be included in a whitelist and, at 1912, in-service monitoring of the first 5 GHz radio channel can be performed. The continuous in-service monitoring of the radio channel may be performed until a determination is made, at 1914, whether radar is detected on the radio channel. If radar is detected, data related to the radio channel will be included in the blacklist, at 1906. Alternatively, if radar is not detected, the continuous in-service monitoring of the radio channel can be performed until an access point device requests the 5 GHz radio channel and a notification is sent to the access point device at 1906.

If the determination, at 1908, is that an acknowledgement has been received (“YES”), at 1916, a soft handover of DFS functionalities to the access point device can be performed. The DFS functionalities can include the continuous in-service monitoring of the 5 GHz radio channel.

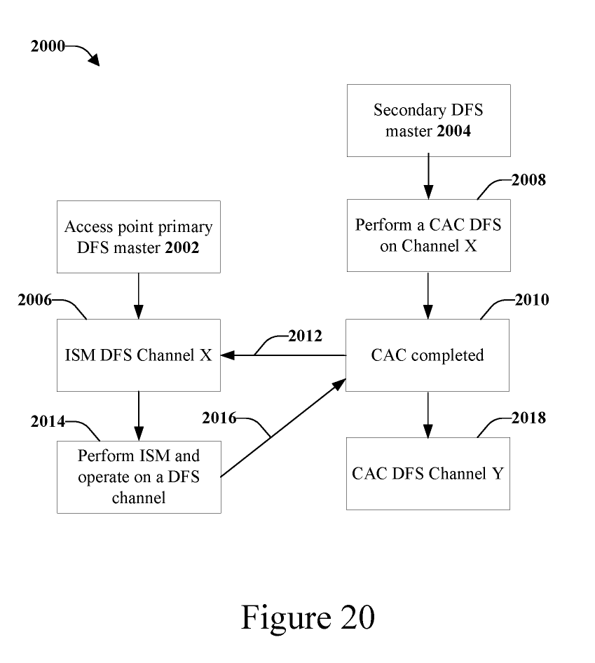

FIG. 20 illustrates an example non-limiting method 2000 for performing a channel availability check on a 5 GHz radio channel at a first device and performing continuous in-service monitoring of the 5 GHz radio channel at a second device in accordance with one or more embodiments described herein. The method 2000 in FIG. 20 can be implemented using, for example, any of the systems, such as a system 1600 (of FIG. 16), described herein.

The method for an access point primary DFS master device (e.g., access point device 2002) is illustrated on the left of FIG. 20; the method for a secondary DFS master device (e.g., DFS master device 2004) is illustrated on the right of FIG. 20. The access point device 2002 may initialize and use a non-DFS channel. For example, at power up or at other times when the access point device 2002 is not operating in the 5 GHz band, it can be operating on a non-DFS channel, at 2006. Thus, during start-up or before the access point device 2002 is cleared on the radar requirement, the access point device 2002 may desire to have nearly immediate networking capability and, therefore, operates on the non-DFS band.

The DFS master device 2004 can be a standalone DFS master device, according to some implementations. The DFS master device 2004 can perform CAC on a DFS radio channel such as a 5 GHz radio channel. Thus, at 2008, the DFS master device 2004 can perform CAC on DFS Channel X. For example, the DFS master device 2004 can perform radar monitoring on Channel X for about sixty seconds. When the CAC is completed, at 2010, and no radar is detected on Channel X, a notification 2012 can be sent to the access point device 2002. The notification, at 2012, can include an indication that Channel X is available for networking use by the access point device 2002.

Based on the notification, at 2012, the access point device 2002 can implement continuous ISM DFS on Channel X, at 2014. At about the same time as the access point device 2002 undertakes the continuous ISM DFS, another notification can be sent to the DFS master device 2004, at 2016. At about the same time as receiving the notification, the DFS master device 2004 discontinuous monitoring of Channel X and can perform a CAC on DFS Channel Y, at 2018.

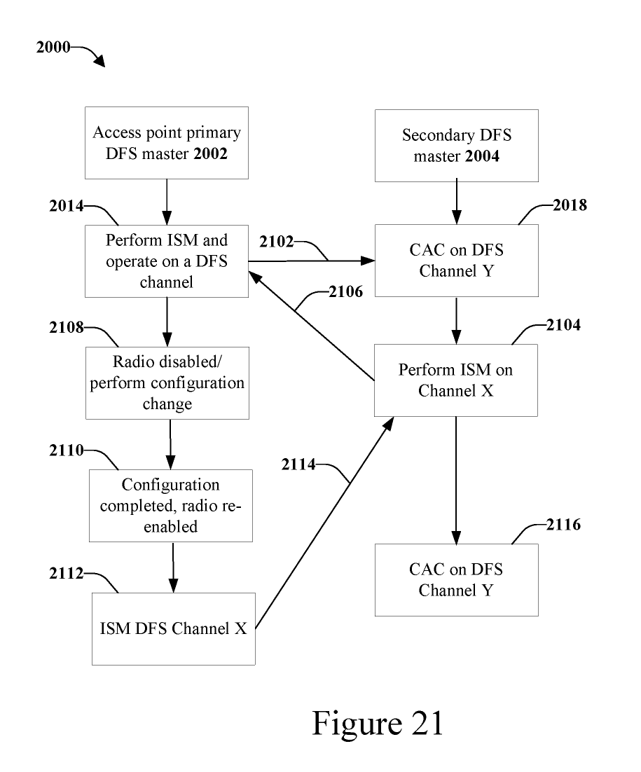

FIG. 21 illustrates an example non-limiting method 2100 for in-service monitoring soft handover during an access point device configuration change in accordance with one or more embodiments described herein. The method 2100 in FIG. 21 can be implemented using, for example, any of the systems, such as a system 1700 (of FIG. 17), described herein.

Similar to FIG. 20, the method for the access point device 2002 is illustrated on the left of FIG. 21; the method for the DFS master device 2004 is illustrated on the right of FIG. 21. As illustrated in FIG. 21, the access point device 2002 can be operating with and performing in-service monitoring on DFS channel X, at 2014 (as discussed with reference to FIG. 20). Since the access point device 2002 is performing the in-service monitoring of DFS Channel X, the DFS master device can perform a CAC on a DFS Channel Y at 2018, as illustrated in FIG. 21.

The access point device 2002 can determine that it will be going out of service, at least temporarily, and can send a notification to the DFS master device 2004, at 2102. Based on this notification, the DFS master device 2004 can, at least temporarily, take over the in-service monitoring of Channel X, at 2104. An acknowledgement can be sent to the access point device 2002, at 2106, providing a confirmation that the DFS master device 2004 is now performing the in-service monitoring on Channel X.

At about the same time as the DFS master device 2004 confirms it is performing the in-service monitoring of channel X, the access point device 2002 is now free to go off line. For example, the access point device 2002 radio can be disabled and/or a configuration change, restart, and so on can be performed, at 2108. After confirmation is complete and/or the radio is enabled, at 2110, the access point device 2002 can start performing in-service monitoring on DFS channel X, at 2112, and a notification can be sent to the DFS master device 2004, at 2114. Thus, the DFS master device 2004 can discontinue the in-service monitoring of Channel X and, at 2116, can perform CAC on another channel, such as DFS Channel X. According to some implementations, at 2112, current whitelists and/or blacklists can be checked instead of attempting to use the same ISM channel, which might no longer be available (e.g., radar event detected while the access point was out of service). For example, the access point, when resuming operation, can check the whitelist for a safe channel to operate on and continue ISM on the selected channel.

As discussed herein provided is a system, which can include multiple DFS Masters, that can perform soft handover of DFS functionalities so that client devices (e.g., devices being serviced by an access point device) does not experience network down time due to waiting for a channel availability check. The soft handover can be performed when a secondary DFS master finishes CAC on a new channel and hands over the in-service monitoring task of that channel to a primary DFS master; thus, allowing the primary radio to switch between DFS channels without the need of performing the channel availability check.

The soft handover can be performed when the primary radio is shut off due to configuration changes such as SSID, password, network mode, and so on. The secondary DFS master can take over the ISM task from the primary DFS master during the time where the primary DFS master's radios are down. Once the primary DFS master's radios are available again, the primary DFS master can take over the ISM task from the secondary DFS master to allow the secondary DFS master to perform CAC on other channels.

As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should generally be construed to mean “one or more” unless specified otherwise or clear from context to be directed to a singular form.

In addition, the terms “example” and “such as” are utilized herein to mean serving as an instance or illustration. Any embodiment or design described herein as an “example” or referred to in connection with a “such as” clause is not necessarily to be construed as preferred or advantageous over other embodiments or designs. Rather, use of the terms “example” or “such as” is intended to present concepts in a concrete fashion. The terms “first,” “second,” “third,” and so forth, as used in the claims and description, unless otherwise clear by context, is for clarity only and does not necessarily indicate or imply any order in time.

What has been described above includes examples of one or more embodiments of the disclosure. It is, of course, not possible to describe every conceivable combination of components or methodologies for purposes of describing these examples, and it can be recognized that many further combinations and permutations of the present embodiments are possible. Accordingly, the embodiments disclosed and/or claimed herein are intended to embrace all such alterations, modifications and variations that fall within the spirit and scope of the detailed description and the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of multiple detector coordination for in-service monitoring of available dynamic frequency selection channels free of radar signals selected from a plurality of 5 GHz radio frequency channels comprising:
providing a beacon generator to generate a first beacon in a first 5 GHz radio channel selected from the plurality of 5 GHz radio channels, providing a radar detector to scan for a first radar signal in the first 5 GHz radio channel, providing a 5 GHz radio transceiver to transmit the first beacon in the first 5 GHz radio channel and to receive the first radar signal in the first 5 GHz radio channel, and providing a switch and embedded processor coupled to the radar detector, the beacon generator, and the 5 GHz radio transceiver;
with the switch and the embedded processor:
communicating to an access point device servicing a client that the first 5 GHz radio channel is available for use based on a first determination that the first 5 GHz radio channel does not comprise the first radar signal; and
performing a soft handover of dynamic frequency selection functionalities to the access point device, wherein the dynamic frequency selection functionalities comprise continuous in-service monitoring of the first 5 GHz radio channel, wherein the radar detector, the beacon generator, and the 5 GHz radio transceiver discontinue the continuous in-service monitoring of the first 5 GHz radio channel.

2. The method of claim 1, further comprising providing a memory and storing in the memory a whitelist that comprises data related to the first 5 GHz radio channel based on a determination that the first 5 GHz radio channel does not contain the first radar signal.

3. The method of claim 2 comprising the switch and the embedded processor, the method further comprising providing the access point device with information related to the whitelist.

4. The method of claim 1, further comprising providing a memory and storing in the memory a blacklist that includes the first 5 GHz radio channel based on a determination that the first 5 GHz radio channel contains the first radar signal.

5. The method of claim 4 comprising the switch and the embedded processor, the method further comprising providing the access point device with information related to the blacklist.

6. The method of claim 1, comprising the switch and the embedded processor, the method further comprising:
receiving from the access point device a confirmation that the access point device has assumed in-service monitoring of the first 5 GHz radio channel prior to the radar detector, the beacon generator, and the 5 GHz radio transceiver discontinuing the continuous in-service monitoring of the first 5 GHz radio channel.

7. The method of claim 6, further comprising:
generating, by the beacon generator, a second beacon in a second 5 GHz radio channel selected from the plurality of 5 GHz radio channels;
scanning, by the radar detector, a second radar signal in the second 5 GHz radio channel;
transmitting, by the 5 GHz radio transceiver, the second beacon in the second 5 GHz radio channel;
receiving, by the 5 GHz radio transceiver, the second radar signal in the second 5 GHz radio channel; and
communicating, with the switch and the embedded processor, to another access point device that the second 5 GHz radio channel is available for use based on a second determination that the second 5 GHz radio channel does not comprise the second radar signal.

8. The method of claim 1 comprising the switch and the embedded processor, the method further comprising:
resuming the continuous in-service monitoring of the first 5 GHz radio channel based on a determination that the access point device is going out of service.

9. The method of claim 8, comprising the switch and the embedded processor, the method further comprising:
returning control of the continuous in-service monitoring of the first 5 GHz radio channel to the access point device based on a notification that the access point device has returned to service.

10. The method of claim 1 comprising the switch and the embedded processor, the method further comprising:
assigning a second 5 GHz radio channel to the access point device based on receipt of an indication from the access point device that radar is detected on the first 5 GHz radio channel; and
providing a memory and storing in the memory a blacklist that includes the first 5 GHz radio channel based on the indication from the access point device.

11. A standalone multi-channel dynamic frequency selection master, comprising:
a beacon generator programmed to generate a first beacon in a first 5 GHz radio channel selected from a set of 5 GHz radio channels;
a radar detector programmed to scan for a first radar signal in the first 5 GHz radio channel;
a 5 GHz radio transceiver programmed to transmit the first beacon in the first 5 GHz radio channel and to receive the first radar signal in the first 5 GHz radio channel; and
a switch and embedded processor coupled to the radar detector, the beacon generator, and the 5 GHz radio transceiver, the switch and the embedded processor programmed to:
communicate to an access point device servicing a client that the first 5 GHz radio channel is available for use based on a first determination that the first 5 GHz radio channel does not comprise the first radar signal; and
perform a soft handover of dynamic frequency selection functionalities to the access point device, wherein the dynamic frequency selection functionalities comprise continuous in-service monitoring of the first 5 GHz radio channel, wherein the radar detector, the beacon generator, and the 5 GHz radio transceiver discontinue the continuous in-service monitoring of the first 5 GHz radio channel.

12. The standalone multi-channel dynamic frequency selection master of claim 11, further comprising a memory that stores a whitelist that comprises data related to the first 5 GHz radio channel based on a determination that the first 5 GHz radio channel does not contain the first radar signal.

13. The standalone multi-channel dynamic frequency selection master of claim 11, further comprising a memory that stores a blacklist that includes the first 5 GHz radio channel based on a determination that the first 5 GHz radio channel contains the first radar signal.

14. The standalone multi-channel dynamic frequency selection master of claim 11, wherein the transceiver receives from the access point device a confirmation that the access point device has assumed in-service monitoring of the first 5 GHz radio channel prior to the radar detector, the beacon generator, and the 5 GHz radio transceiver discontinuing the continuous in-service monitoring of the first 5 GHz radio channel.

15. The standalone multi-channel dynamic frequency selection master of claim 11, wherein the switch is further configured to resume the continuous in-service monitoring of the first 5 GHz radio channel based on a determination that the access point device is out of service.

16. The standalone multi-channel dynamic frequency selection master of claim 15, wherein the switch is further configured to return control of the continuous in-service monitoring of the first 5 GHz radio channel to the access point device based on a notification that the access point device has returned to service.

17. A method, comprising:
determining, by a device comprising a processor, whether radar is detected on a first dynamic frequency selection radio channel;
sending to a first access point, by the device, an indication that the first dynamic frequency selection radio channel is available for use by the first access point;
relinquishing control, by the device, an in-service monitoring of the first dynamic frequency selection radio channel based on receipt of another indication that the first access point has commenced the in-service monitoring of the first dynamic frequency selection radio channel;
determining, by the device, whether radar is detected on a second dynamic frequency selection radio channel; and
performing, by the device, in-service monitoring of the second dynamic frequency selection radio channel.

18. The method of claim 17, further comprising:
sending to a second access point, by the device, an indication that the second dynamic frequency selection radio channel is available for use by the second access point;
relinquishing control, by the device, in-service monitoring of the second dynamic frequency selection radio channel based on receipt of an indication that the second access point has commenced the in-service monitoring of the second dynamic frequency selection radio channel;
determining, by the device, whether radar is detected on a third dynamic frequency selection radio channel; and
performing, by the device, in-service monitoring of the third dynamic frequency selection radio channel.

19. The method of claim 17, further comprising:
receiving, by the device, a notification from the first access point, the notification informs the device that radar is detected on the first dynamic frequency selection radio channel;
notifying the first access point, by the device, that the second dynamic frequency selection radio channel is available for use; and
relinquishing control, by the device, in-service monitoring of the second dynamic frequency selection radio channel based on receipt of an indication that the first access point has commenced the in-service monitoring of the second dynamic frequency selection radio channel.

20. The method of claim 19, further comprising:
performing, by the device, a channel availability check on the first dynamic frequency selection radio channel;
performing, by the device, in-service monitoring of the first dynamic frequency selection radio channel based on a determination that radar is no longer present on the first dynamic frequency selection radio channel; and
placing, by the device, data related to the first dynamic frequency selection radio channel on a whitelist of available radio channels.
